(19) United States
(12) Patent Application Publication
(10) Pub. No.: US 2026/0370620 A1
(43) Pub. Date: Nov. 19, 2026

(54) DISTRIBUTED NETWORK COMMUNICATION SYSTEMS AND METHODS

(71) Applicant: Walmart Apollo, LLC, Bentonville, AR (US)

(72) Inventors: Ashish K. Vishwakarma, Bengaluru (IN); Badrinath V. Kulkarni, Bangalore (IN); Dhaval D. Vyas, Gandhidham (IN); Piyush Yaduvanshi, Rampur (IN); Rahul Chauhan, Greater Noida (IN); Sreekanth Suruvu, Hindupur (IN)

(21) Appl. No.: 19/208,328

(22) Filed: May 14, 2025

(51) Int. Cl. H04L 51/07; H04L 51/216

(52) U.S. Cl. CPC H04L 51/07; H04L 51/216

(57) ABSTRACT

Some embodiments provide systems comprising: a processing resource; and a non-transitory machine readable medium storing instructions, that when executed, cause the processing resource to: receive, from a first user, through a first containerized application a first message of a first conversation; append a first data segment to an appended data stream; and each of multiple active containerized applications receives the appended data stream to receive each data segments of multiple different conversations, wherein a second containerized application when executed: determines that the second containerized application is associated with the first conversation ID, and identifies that the second containerized application is assigned to forward messages of the first conversation to a second user; and transmits the first message to the second user in response to the second containerized application identifying that the second containerized application is assigned to relay communications with the second user for the first conversation ID.

### TECHNICAL FIELD

This invention relates generally to controlling electronic communications.

### BACKGROUND

Electronic communications are needed for many wide area communications systems, such as web or Internet communications systems. These communication systems use various physical mechanisms and communication protocols. Various signaling may be used to establish links between different user of a network.

### BRIEF DESCRIPTION OF DRAWINGS

Disclosed herein are embodiments of systems, apparatuses and methods pertaining to controlling and enabling communications. This description includes drawings, wherein:

FIG. 1 illustrates a simplified block diagram of an example distributed network communication system, in accordance with some embodiments.

FIG. 2 illustrates an example functional block diagram of an example communication system, in accordance with some embodiments.

FIG. 3 illustrates a simplified functional diagram of an example conversation creation process, in accordance with some embodiments.

FIG. 4 illustrates a simplified functional diagram of an example connection establishment process, in accordance with some embodiments.

FIG. 5 illustrates a simplified functional diagram of an example connection establishment process, in accordance with some embodiments.

FIG. 6 illustrates a simplified functional diagram of an example connection tracking process, in accordance with some embodiments.

FIG. 7 illustrates a simplified functional diagram of an example connection tracking process, in accordance with some embodiments.

FIG. 8 illustrates an example timeline representation of managing connection identifiers (IDs), in accordance with some embodiments.

FIG. 9 illustrates a flow diagram of an example process of controlling communications, in accordance with some embodiments.

FIG. 10 illustrates a flow diagram of an example process of establishing a conversation, in accordance with some embodiments.

FIG. 11 illustrates a flow diagram of an example process to tracking user status in participating in the conversation, in accordance with some embodiments.

FIG. 12 illustrates a flow diagram of an example process to communicate stored messages to a user upon the user reestablishing an online connection status enabling active continued participation in the conversation, in accordance with some embodiments.

FIG. 13 illustrates a flow diagram of an example process of connecting a user to a different containerized application upon reestablishing a connection and/or online status to a particular conversation after having been disconnected from the conversation, in accordance with some embodiments.

FIG. 14 illustrates a flow diagram of an example process of attempting to confirm an online status of a user, in accordance with some embodiments.

FIG. 15 depicts example system that includes one or more non-transitory, machine readable media encoded with example instructions executable by one or more processing resources, in accordance with some embodiments.

FIG. 16 depicts example system that includes one or more non-transitory, machine readable media encoded with example instructions executable by one or more processing resources, in accordance with some embodiments.

FIG. 17 depicts example system that includes one or more non-transitory, machine readable media encoded with example instructions executable by one or more processing resources, in accordance with some embodiments.

FIG. 18 illustrates an example system for use in implementing methods, techniques, devices, apparatuses, systems, servers, sources and providing communications, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Communications are essential in numerous applications and industries. The ability to provide efficient and reliable communications is often critical. Some embodiments provide enhanced communications systems and methods of enabling improved communications through a scalable based architecture optimizing the use of containerized applications specific to communications. The system can replace at least inefficient long polling systems that incur relatively high latency and resource overhead, with a comprehensive system that combines directed containerized applications that can scale in cooperation with one or more appended streams of communication messages of multiple different active communication sessions providing seamless cross-application message routing while enabling horizontal scalability, which can provide unidirectional and/or sustained bidirectional communication between two or more users. Some embodiments further enhance communications in part through a tracking of user online-offline status that improves bandwidth usage and provides message delivery to active users connected to the system. Additionally, some embodiments incorporate integrated dynamic authentications and authorizations providing secure access to conversations and message delivery. By integrating these components into a cohesive design, some embodiments provide low-latency, resource-efficient, and scalable communication systems that overcome many of the challenges experienced by other communications systems.

Some embodiments provide systems that comprise one or more processing resources that are communicatively coupled with one or more non-transitory machine readable medium storing instructions that when executed cause the processing resource to: receive, from a first user via a distributed communications network, through a first containerized application of multiple active containerized applications a first message of a first conversation between the first user and a second user; append, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and each of the multiple active containerized applications receives the appended data stream over time to receive each of sequential data segments of the multiple different conversations from the appended data stream, wherein a second containerized application of the multiple containerized applications when executed: determines, in response to receiving the first data segment from the appended data stream, that the second containerized application is associated with the first conversation ID, and identifies, based on the first conversation ID, that the second containerized application is previously assigned to forward messages of the first conversation to the second user; and transmits, via the distributed communications network, the first message to the second user in response to the second containerized application identifying that the second containerized application is assigned to relay communications with the second user for the first conversation ID.

Some embodiments provide methods comprising: receiving, from a first user via a distributed communications network through a first containerized application of multiple active containerized applications, a first message of a first conversation between the first user and a second user; appending, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and receiving, at each of the multiple active containerized applications, the appended data stream over time to receive each of sequential data segments of the multiple different conversations from the appended data stream; determining, at a second containerized application of the multiple containerized applications and in response to receiving the first data segment from the appended data stream, that the second containerized application is associated with the first conversation ID; identifying, at the second containerized application and based on the first conversation ID, that the second containerized application is previously assigned to forward messages of the first conversation to the second user; and transmitting, by the second containerized application via the distributed communications network, the first message to the second user in response to the second containerized application identifying that the second containerized application is assigned to relay communications with the second user for the first conversation ID.

Still further embodiments provide one or more non-transitory machine readable medium storing instructions that, when executed, cause a processing resource to: receive, from a first user via a distributed communications network through a first containerized application of multiple active containerized applications, a first message of a first conversation between the first user and a second user; append, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and receive, at each of the multiple active containerized applications, the appended data stream over time to receive each of sequential data segments of the multiple different conversations from the appended data stream; determine, at a second containerized application of the multiple containerized applications and in response to receiving the first data segment from the appended data stream, that the second containerized application is associated with the first conversation ID; identify, at the second containerized application and based on the first conversation ID, that the second containerized application is previously assigned to forward messages of the first conversation to the second user; and transmit, by the second containerized application via the distributed communications network, the first message to the second user in response to the second containerized application identifying that the second containerized application is assigned to relay communications with the second user for the first conversation ID.

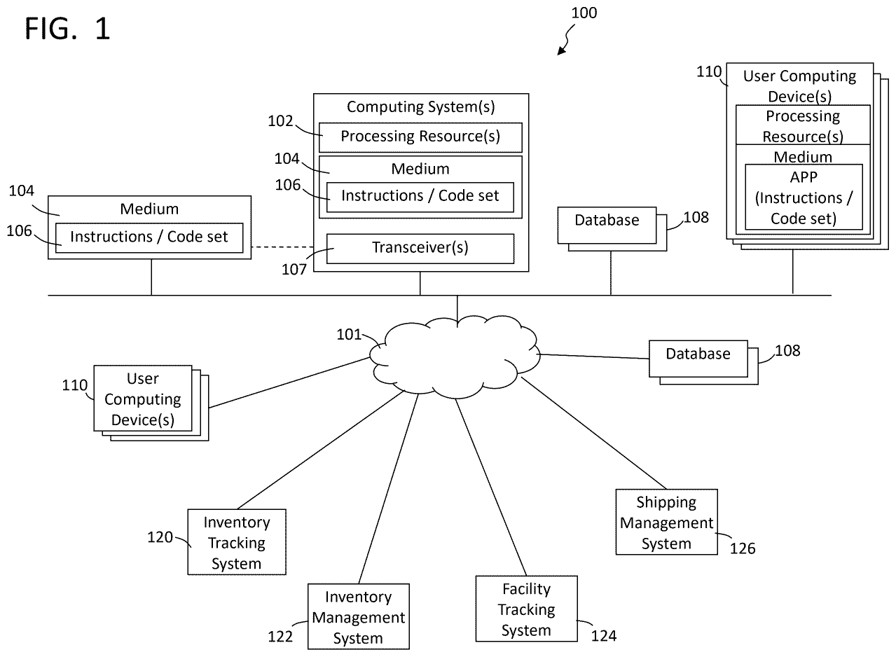

FIG. 1 illustrates a simplified block diagram of an example distributed network communication system 100, in accordance with some embodiments, that provides reliable and enhanced communications between two or more user. The users can be one or more human users communicating through respective user devices operated by the respective person (e.g., smartphone, computer, laptop, tablet, smart wearable device, and/or other such devices), one or more systems, one or more computers, one or more automated response systems, one or more artificial intelligence systems, other such systems or a combination of two or more of such systems. For example, one of the users may be an automated chat system that enables remote users (e.g., customers, employees, etc.) to submit various questions. Further, in some implementations, a user may be implemented through one or more generative automated intelligence (AI) systems that can communicate and/or respond to one or more other humans, systems, servers, etc. Other types of communications can be provided through the communication system 100, which can include an exchange of audio content, image content, video content, textual content, instructions content, programming instructions and/or code, graphical user interface content and/or control code, other such content, or a combination of two or more of such content.

The communication system 100 can include one or more electronic processing resources 102 that may include one or more microcontrollers, one or more microprocessors, one or more central processing unit cores, one or more application-specific integrated circuits (ASIC), one or more servers, one or more field programmable gate arrays (FPGA), control logic, other such systems or a combination of two or more of such systems. The communication system 100 further includes one or more machine readable mediums 104 that may be non-transitory and include for example one or more random access memory (RAM), one or more read-only memory (ROM), one or more electrically erasable programmable read-only memory (EEPROM), one or more flash memory, one or more hard disk drives, other such mediums, or a combination of two or more of such mediums. Some or all of the mediums 104 can include one or more databases, which are accessible via a distributed computer and/or communications network 101, and that maintain and store relevant data, instructions, commands, code, other such information, or a combination of two or more of such information. Further, the medium 104 may be part of a processing resource 102, external to and accessible to one or more processing resources 102, or a combination of internal and external mediums. Additionally, one or more mediums may be remote and provide distributed and/or redundant storage. The one or more distributed networks 101 can be substantially any relevant wired and/or wireless computer and/or communications networks (one or more local area networks (LAN), one or more wireless area networks (WAN), one or more other wireless networks (e.g., cellular, Wi-Fi, Bluetooth, LoRa, LoRa-WAN, etc.), other such networks, or a combination of two or more of such networks).

The processing resource 102 may execute instructions 106 (e.g., programming and/or one or more software sets of code) stored on one or more machine readable mediums 104 that when executed by the processing resource 102 causes the processing resource to perform functions of the communication system 100. Additionally or alternatively, the processing resource 102 may include electronic circuitry to perform some or all of the functionality described herein. The communication system 100 may also include other hardware components, such as physical storage (e.g., hard disk drive, a solid state drive, or the like, or a plurality of such storage devices (e.g., an array of disks)), and may be locally attached (i.e., installed) in the communication system 100. In some implementations, physical storage may be accessed as a block storage device. The processing resource is communicatively coupled with and/or controls one or more wired and/or wireless communications transceivers 107, transmitters and/or receivers that communicatively coupled with the one or more distributed communications networks 101. The processing resource 102 controls communications from and/or to the processing resource, and/or from and/or to the communication system 100, to communicate instructions and/or commands, manage data distribution, retrieve information, receive commands and/or instructions, communicate status information, and/or other such communications.

The communication system 100 can include and/or is in communication with one or more internal and/or external databases 108 that can store data for use by the processing resource 102, other local systems and/or remote systems. Further, the databases may be part of the processing resource 102, the medium 104 and/or one or more separate mediums. The communication system 100 can further include and/or is accessible by numerous user computing devices 110 (e.g., computer, laptop, tablet, smartphone, user wearable system, etc.) that are used by users to communicate. In some embodiments, the communication system 100 can include, be a part of and/or can be communicatively coupled with one or more other users, one or more service providers, information resources, retail entities, entities that provide raw product(s), raw production material(s), shipping entities, and/or other such entities. The communication system 100 may be part of a retail entity that distributes and sells product. As such, the communication system 100 may include and/or be communicatively coupled with an inventory tracking system 120 that can track inventory, inventory management system 122, facility tracking system 124, a shipping management system 126 that can manage the distribution of products from one or more facilities and/or to one or more facilities (e.g., manage shipping to customers), other such systems, or a combination of two or more of such systems.

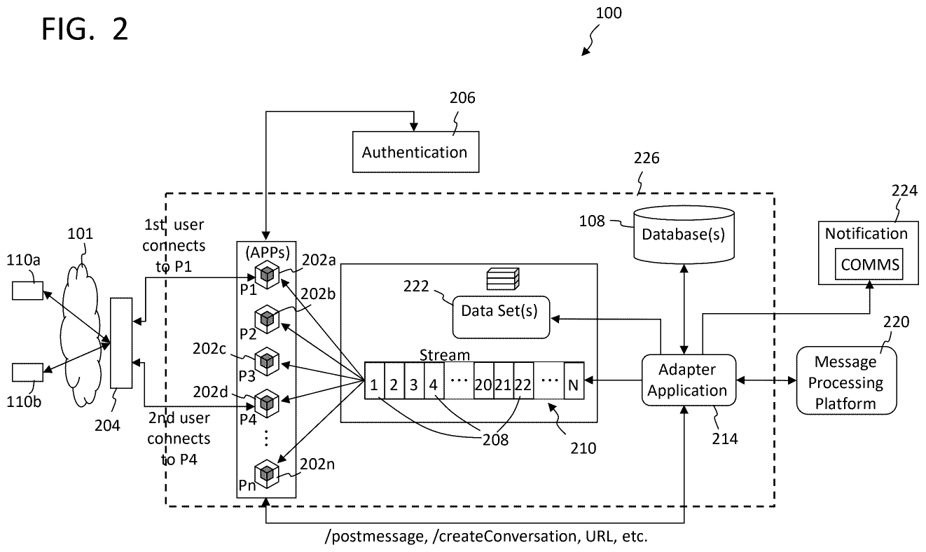

FIG. 2 illustrates an example functional block diagram of an example communication system 100, in accordance with some embodiments. Referring to FIGS. 1 and 2, in some embodiments, one or more of the processing resources 102 in executing instructions can implement one or more communication containerized applications 202. These containerized applications 202 can be single instances of a running process, which can be implemented in a cluster and each can encapsulate one or more coupled containers that perform an intended function specific to establishing a conversation with one or more users via their respective user devices 110 over the distributed communications network 101. In some embodiments, for example, the containerized applications are container “pods” of a Kubernetes container orchestration system by The Linux Foundation, microservice applications by Lumigo, docker applications and docker engine by Docker, Inc., and/or other such containerized applications. The containerized applications 202 can be deployed in a modular, scalable, and manageable way, with each containerized application 202 providing communication with one or more designated or assigned users. The cluster of containerized applications 202 enables different users of a single conversation to be cooperated or assigned to different containerized applications, while the communication system 100 ensuring accurate routing of different messages of the conversation from the respective users participating in a respective conversation. As such, users of a single conversation can be assigned different containerized applications 202. In some embodiments, the communication system 100 further enhances the communication management in part by eliminating direct pod addressing and providing dynamic scaling of the system while maintaining reliable message delivery.

The communication system, in some embodiments, further addresses critical limitations of real-time communications with the use of a scalable websocket-based architecture that is implemented for use with containerized application environments. The websocket architecture can employ one or more appended streams that queue communication messages providing seamless cross-containerized application communication routing. As such, the communication system 100 provides dynamic and scalable communication routing across multiple containerized applications, in establishing low-latency, real-time communications in containerized application environments.

Still referring to FIGS. 1-2, each of the containerized applications 202 can receive communication messages from external users, and transmit messages to respective users. In some implementations, for example, a first user through a first user device 110a can be connected with and/or assigned a first containerized application 202a of the cluster of multiple active containerized applications, and a second user through a second user device 110b can be connected with and/or assigned a second containerized application 202d. In some embodiments, the communication system includes one or more security and/or communication processing applications 204, such as but not limited to a cybersecurity and/or cloud computing distributed cloud service (e.g., by Akamai Technologies), one or more firewall and/or security applications (e.g., by F5, Inc.), network and/or website optimization applications (e.g., Torbit), other such processes, or a combination of two or more of such processes.

Incoming communication messages can be authenticated through one or more authentication processes by one or more authentication systems 206 and/or applications, which can perform functions such as confirming a user, a user device, a system, encryption, keys, etc. (e.g., using an Identity and Access Management (IAM)), Single sign-on (SSO) authentication, etc.). Upon authenticating users and/or messages of communications, the containerized applications 202 can provide a gateway with users. A containerized application, such as a first containerized application 202a of the cluster of multiple active containerized applications 202, can receive, via the distributed communications network 101 from a first user 110a, a first message of a first conversation between the first user 110a and a second user 110b. This first message can, in some embodiments, be appended as part of a first data segment 208 to an appended data stream 210, in response to receiving the first message of the first conversation, to which each data segment of multiple different conversations is sequentially appended over time. The data segments can include the conversation message communicated and a corresponding conversation identifier (ID). In some implementations, the data segment may include a sender user identifier. Further, in some instances, the data segment may include one or more intended recipient user identifiers.

The appended data stream 210 is received, in some embodiments, at each of the multiple active containerized applications 202a-202n over time to receive each of sequential data segments 208 of the multiple different conversations from the appended data stream. The respective containerized applications 202 can use the conversation ID, sending user ID and/or other information to determine whether the respective containerized application is associated with the conversation. For example, a second containerized application 202d of the multiple containerized applications when executed and determine, in response to receiving a first data segment 208 from the appended data stream 210, that the second containerized application is associated with the identified conversation ID, and identifies, based on the conversation ID, that the second containerized application 202d is previously assigned to forward messages of the conversation to a second user 110b. The second containerized application 202d can transmit, via the distributed communications network 101, the message to the second user 110b in response to the second containerized application identifying that the second containerized application is assigned to relay communications with the second user for the first conversation ID.

Accordingly, in some embodiments, each containerized application receives the queued data segments of the appended data stream. The containerized applications 202 do not have to be addressed, and instead the containerized applications can individually determine whether a particular data segment is associated with a conversation for which that respective containerized application is responsible. Further, the containerized application can then determine whether it should transmit the data segment and to which user the data segment is to be communicated. In some embodiments, the containerized applications disregard a data segment based on a determination that the respective containerized application is not associated with the conversation ID and/or is not responsible to transmit the data segment.

Again, in some embodiments, messages and/or requests, whether for initiating a new conversation, continuing a conversation and/or upgrading to a websocket connection, are authenticated and authorized. The communication system 100 can implement one or more authentication systems 206, platforms, applications and/or processes. When a user requests to create a conversation, the request body can specify the users who are authorized to join a particular conversation. One or more of the users can be validated against the authentication systems before further actions are allowed. The one or more authentication systems 206 systems can perform authentication checks, verifying identities and roles of the user, confirming user devices, authentication token(s), validating communication and/or encryption keys, other such authentications or a combination of two or more of such authentications. In some embodiments, once a user and/or message is authenticated, the system can limit access to users specified (e.g., in a createConversation body) for a particular conversation.

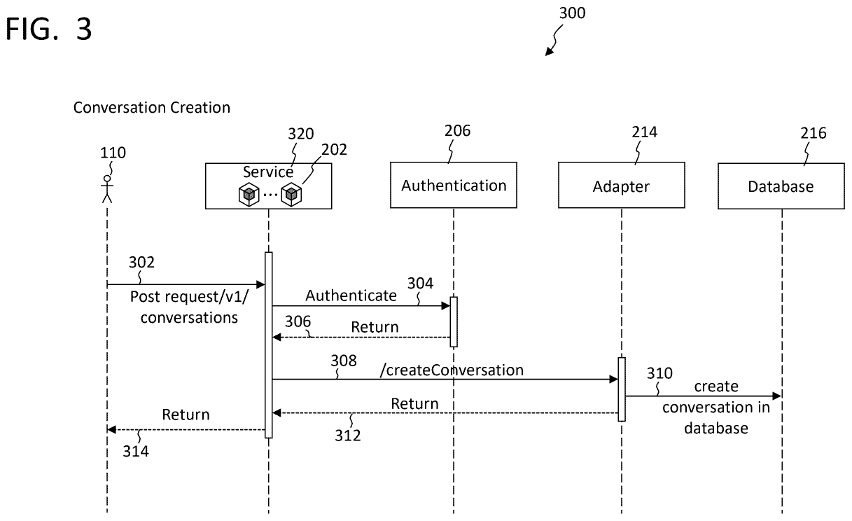

In some embodiments, when a user initiates a conversation, the communication system 100, in some embodiments, can activate a create conversation application program interface (API), which can generate a new conversation ID and get a list of authorized users. FIG. 3 illustrates a simplified functional diagram of an example conversation creation process 300, in accordance with some embodiments. Referring to FIGS. 1-3, the communication system 100 can receive 302, from a user, a conversation API call or request to establish and initiate a conversation or communication. In some instances, the request includes at least a requesting user identifier (e.g., an identifier of a user device 110), and in some instances can include one or more additional or alterative identifiers. The processing resource 102, in executing instructions, can implement a network service 320 which can, in some implementations, route relevant information as an authentication request 304 to the authentication system 206, which when authenticated can return an authorization 306. The network service 320, in some embodiments, can be implemented through a websocket service that comprises and/or implements the containerized applications 202. The websocket service of the network service 320 can establish communications connections and enable continuous data communication between the service and the user device without a user device having to repeatedly and/or constantly poll the network service server or need to establish multiple connections in both directions. As such, some embodiments provide a websocket platform 226 that provides websocket-based communications. In some embodiments, when a requesting user is not already associated with a containerized application, an association is established in response to the conversation request of the requesting user with one of the containerized applications (e.g., first user 110a with a first containerized application 202a). The respective containerized application 202 of the network service 320, in some embodiments, can communicate a create conversation request 308 (e.g., “/createConversation”) to an adapter application 214 executed by the processing resource 102. The adapter application 214 can create a conversation ID 310 corresponding to the request, and in some embodiments can be exclusively associated with the particular conversation. The adapter application 214, in some embodiments, can comprise a websocket adapter. The conversation ID can be generated from and/or be associated with the one or more identifiers provided in the call or request, such as one or more user identifiers, an invoice identifier, other such information or a combination of two or more of such information.

In some embodiments, the conversation ID can be stored securely in one or more databases 216. Similarly, in some implementations, one or more users of the conversation are associated with the conversation ID, and the processing resource can maintain, within one or more databases 216 (e.g., conversation database) and/or data sets the association between the conversation ID and each of the users (e.g., user IDs) authorized to participate in the particular conversation. This enables the system to track which users 110 are allowed to connect to a content of a particular communication (e.g., websocket) once the conversation begins, during the conversation and/or to acquire conversation content. In some embodiments, the adapter application 214 can communicate a confirmation 312, which can include a conversation ID and other relevant data to the containerized applications 202. In some embodiments, the confirmation 312 can return a link, address, websocket URL, and/or other such routing information, which can be forwarded 314 to the one or more users 110 to be used by one or more users in being connected for sending and/or receiving messages of a conversation.

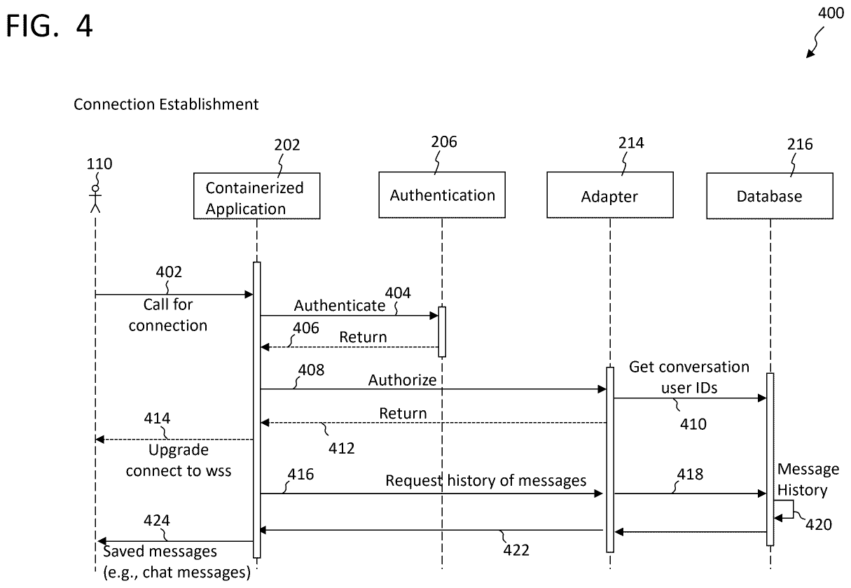

The conversation system 100 can further enhance security in part through a confirmation of users to a particular conversation ID (e.g., a particular websocket). FIG. 4 illustrates a simplified functional diagram of an example connection establishment process 400, in accordance with some embodiments. The conversation system 100 can receive a connection request 402 from a particular user 110 to connect, for example based on a websocket URL. A containerized application 202 can forward 404 a unique identifier, user ID and/or other relevant information, and/or message content to the authentication system 206. The authentication system 206 can ensure the integrity and security of the communication connection and/or users. When the authentication is successful, an authentication result can be returned 406. The authenticated user is then provided access to the conversation with an authorization call 408 directed to the adapter application 214. Using the conversation ID, and in some implementations user IDs of one or more of the users of the conversation, the adapter application 214 can access 410 one or more databases 216 (e.g., conversation database) and/or data sets to check and confirm the one or more users are designated and associated with the conversation. Some embodiments can return 412 a confirmation of the association of the user with the particular conversation. The containerized applications 202 can be assigned, maintains 414 and/or establishes the conversation connection with the respective user devices 110 (e.g., using a websocket URL) enabling the user device and/or browser of the user device to continuously receive and/or transmit data from and/or to the network service 320 without having to constantly poll the network service 320 or need to establish multiple connections in one or both communication directions. A user device continues to communicate with the respective containerized application 202 for the conversation ID, while the user remains active or online.

In some embodiments, upon a user connecting with a containerized application 202, the containerized application 202 can initiate a request 416 to the adapter application 214 that can query 418 the database to determine whether one or more messages were saved for the particular conversation ID and user ID while the user was offline or otherwise temporarily inactive. The database 216 can identify 420 one or more messages, when one or more messages have not already been forwarded to the user. In some embodiments, for example, the API call 402 or other communication can identify which messages corresponding to the conversation ID the user device 110 previously received, if any, and the adapter application 214 and/or database can determine whether one or more additional messages have been saved for the conversation ID. The database and adapter application can return 422 the saved conversation messages to the containerized application 202 in response to the saved message request 416 and/or connection request 402. In some embodiments, the saved message are returned directly to the containerized application without being incorporated into the data stream 210. The containerized application 202 can forward 424 the saved messages to the user device 110.

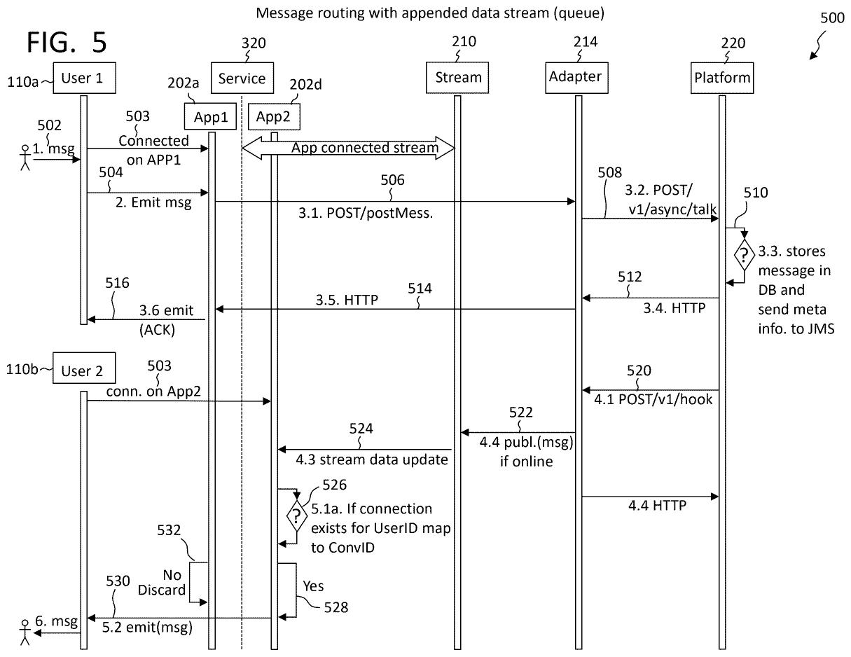

Once a conversation is created and connections with users established, the communication system 100 enables message content to be exchanged between two or more users that are participating in a particular conversation. FIG. 5 illustrates a simplified functional diagram of an example connection establishment process 500, in accordance with some embodiments. A sending first user 110a can initiate the communication of a message 502 to one or more recipient second users 110b. The message can be one of multiple messages of the particular conversation. When the conversation is established, the first user 110a is associated 503 with a first containerized application 202a for the particular conversation, and the second user is associated with a second containerized application 202d. In some instances, both users may be associated with the same containerized application, but in most instances the different users of a conversation are associated with different containerized applications enabling a more robust and scalable system. The message is directed 504 to the assigned containerized application 202a, which in some embodiments is based on the websocket URL and/or conversation ID. In some embodiments, the message and/or user can be authenticated, as described above and further below.

The containerized applications are cooperated with the adapter application 214 to provide messages to be incorporated into the appended data stream 210 and receive messages from the data stream. The message 502 and/or relevant portions of the message are directed 506 to the adapter application 214, which can parse the message to obtain a conversation ID. The adapter application 214 can further obtain at least a sender user ID from and/or based on the message, and in some embodiments one or more intended recipient user IDs. In some embodiments, the message and/or the conversation ID and user ID are provided 508 to a message processing platform 220 that can in part confirm 510 that the user associated with the user ID is an intended and authenticated participant of the conversation associated with the conversation ID. In some embodiments, associations between a conversation ID and user IDs are maintained within one or more databases 216 and/or other data set, and used by the message processing platform 220 and/or adapter application 214 to confirm the association before authorizing a message to be forwarded as part of the particular conversation corresponding to the received conversation ID. In some embodiments, some or all of the messages can be maintained in one or more databases 108 (e.g., a message database). The adapter application, in some embodiments, prevents a message from being appended to the appended data stream in response to determining that a user ID is not associated with the respective conversation ID. Additionally or alternatively, a user not associated with a conversation is prevented from connecting with the conversation, where messages received from that user not associated with a conversation ID are not maintained or forwarded, and/or messages are not communicated to the user not associated with a conversation ID.

Further, in some embodiments, the adapter application 214 can confirm that an intended recipient user is actively participating in the conversation (e.g., is actively online). The message processing platform 220 can provide an acknowledgment 512 to the adapter application 214, which in some embodiments can be forwarded 514 to the respective first containerized application 202a, which may optionally provide an acknowledgement 516 to the first user 110a via a first user device.

The message processing platform 220 can provide a confirmation 520 to the adapter application 214 when the sending user 110a, and in some instances the intended recipient user 110b, is confirmed as authenticated and/or authorized to participate in the conversation corresponding to the conversation ID. The adapter application 214 and/or the message processing platform 220, in some embodiments, obtain an intended recipient ID and confirms that the intended recipient is online and/or is currently participating in the conversation. In response to the containerized application 202a receiving the message of the conversation, the adapter application 214 can append a data segment 208 to the appended data stream 210. Again, the appended data stream comprises a series of data segments each corresponding to one or more messages of different conversations being enabled through the communication system 100. As such, each data segment 208 corresponds with one of multiple different conversations, and each data segment is sequentially appended over time establishing the stream of multiple data segments that are communicated 522 over time to the containerized applications 202.

The communication system 100 can leverage a queue system in providing the appended data stream (e.g., Redis Streams) to enable efficient, horizontal scaling and real-time message delivery. The data segments can comprise one or more messages of the respective conversation and a conversation identifier (ID) corresponding to the conversation. Further, in some implementations, the data segment may include one or more intended recipient user IDs, a sender user ID, authentication information, other such information, or a combination of two or more of such information. In instances where the intended recipient user is identified as offline, the adapter application 214 can, in some embodiments, at least temporarily prevent a message intended for the offline user from being appended to the appended data stream 210, while still causing the messages to be stored in a message database 108 in association with the first conversation ID. Similarly, in some embodiments, the message processing platform 220 can, in response to determining that a user ID is not associated with a particular conversation ID, notify the adapter application 214 of the inconsistent association, which may at least temporarily prevent a communication message from being appended to the appended data stream 210.

Further, in some instances, the adapter application 214 can determine and/or be notified, at some time that is subsequent in time to the identification that a user is offline, that the user is again online and is associated with the particular conversation ID. It is noted that the user is often associated with a different containerized application 202 than before going offline. Again, because the multiple active containerized applications receive the data stream and independently determine whether to forward the message, users can be readily disassociated with a containerized application and subsequently reassociated with a different containerized application while participating in a single conversation. Based on the user being back online to participate in the conversation, the adapter application 214 can identify whether one or more messages associated with the conversation ID are pending and saved in the message database, such as a message received while the user was offline that was saved to the database. As described above, messages for the different conversations can in some implementations be at least temporarily stored in a database 108 (e.g., a message database). In some embodiments, a user device upon re-establishing a connection can specify the messages of the conversation that have previously been received and/or a most recent message that was received by the user device. Based on the identification of the received messages, the adapter application and/or database can determine whether one or more additional messages have been saved that have not been received by the user device 110. When one or more messages are saved, the adapter application 214 can communicate through the containerized application to the user the saved messages, and which can be communicated independent of the data stream 210.

The appended data stream 210 is communicated 524 to each of the multiple active containerized applications 202, such that each of the active containerized applications receives the appended data stream 210 over time to receive each of sequential data segments 208 of the multiple different conversations from the appended data stream 210. Each of the multiple active containerized applications when executed can determine 526, in response to receiving a data segment 208 from the appended data stream 210, whether the containerized application is associated with the respective conversation ID, and can identify, based on the conversation ID, that the respective containerized application is previously assigned to forward messages of the conversation corresponding to the conversation ID to an intended user (e.g., recipient user). In response to a containerized application (e.g., the second containerized application 202d) identifying 528 that the containerized application is assigned to relay communications with a second user 110b for the conversation ID, the containerized application can cause the message of the data segment 208 to be transmitted 530 via one or more transceivers 107 to the second user 110b. Alternatively, when the containerized application 202b, in response to receiving the data segment 208, determines 532 that the containerized application is not associated with the conversation ID, the containerized application can disregard that data segment. Further, the containerized application can identify when it is associated with the sending user and does not re-transmit the message back to the sending user. Accordingly, in some embodiments, each active containerized application receives each data segment 208 of the appended data stream 210, which avoids having to individually address the containerized applications. Similarly, each containerized application identifies when it is to cause a message to be communicated, which simplifies the routing of messages while reducing computational processing through the simplified containerized applications implementing specific instructions to identify messages of conversations for which it is associated.

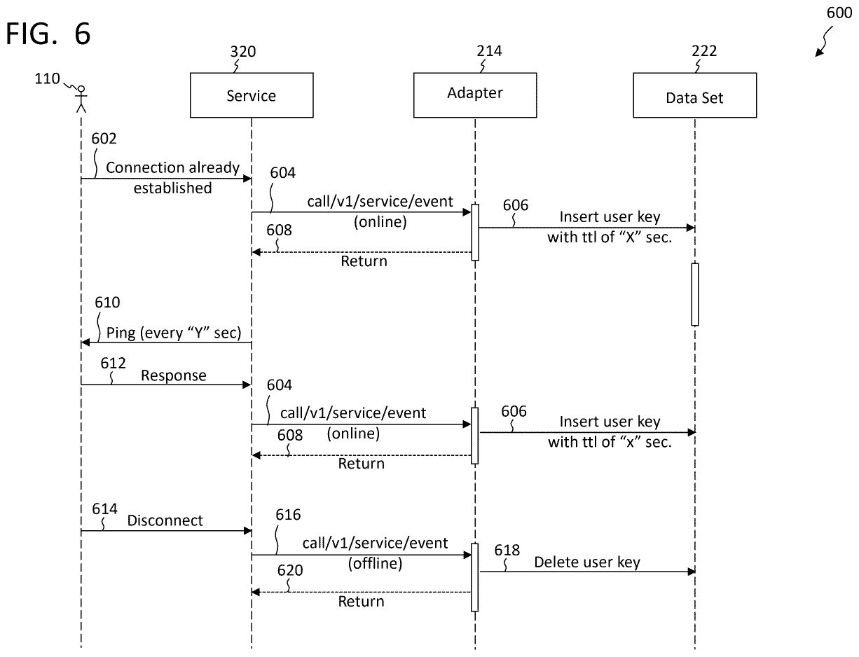

Some embodiments enhance the reliability and consistency of the communications in part through the tracking of users' continued participation in the conversation and/or whether the user is still connected with the conversation (e.g., still online). FIG. 6 illustrates a simplified functional diagram of an example connection tracking process 600, in accordance with some embodiments. The detection of a presence and/or active participation of a user with a conversation enhances scalability and efficiency. Some embodiments utilize a data set 222, table, database and/or other record system to track the presence of users. The data set 222, in some embodiments, can comprise data organized into a mapping between an entry (e.g., a key) and one or more field-value entries, pairs and/or other relevant data. The tracking, in some implementations, can utilize received communication, responses and/or other such information in cooperation with timing, such as but not limited to a time-to-live (TTL) factor. A communication connection 602 with a particular user 110 is established via the network service 320 between the particular user 110 and a containerized application 202. A communication message, status data, or the like can be received associated with the conversation ID, such as audio content, textual content, data, request, response, other such content or a combination of two or more of such content. When a conversation connection is established (e.g., websocket) and/or in response to a communication from the user 110, the network service can provide an online status update 604 to the adapter application 214 that can mark 606 a user as online in one or more data sets, tables, databases, other such record or a combination of two or more of such records. In some embodiments, for example, the adapter application can incorporate online status data into one or more Redis sets, which may in some implementations include one or more hashsets. The online status data can comprise a connection ID, a conversation ID, a corresponding user ID, other such data, and in some implementations further includes timing information, such as but not limited a time of the most recent communication, a time of entry into the set, a time-to-live (TTL) timing, a time threshold (e.g., “X” number of seconds), other such timing information, or a combination of two or more of such timing information. For example, the timing information can comprise a TTL with a threshold period of time (e.g., 10 seconds, 20 seconds or other relevant time period). In some embodiments, a confirmation 608 or other return reply is provided to the network service 320. In some embodiments, the containerized applications 202, the adapter application 214, data set 222 and/or other system components may be implemented as part of a websocket platform.

The data sets 222 can be used to store the marking or indication of an online/offline status. A data set entry and/or key can be generated, which in some embodiments can be is based on a conversation ID and/or other domain configuration. Further, a default value can be set for new key creation. Additionally, in some embodiments, a connection ID is assigned for a connection between the user and a containerized application. The connection ID can be sent to request and stored in a respective data set with and expiration. In response to an offline determination and/or during an offline call, the connection ID can be removed from the data set. This is done because a user can reconnect with the system, such as because of glitches (e.g., network and/or connection glitch or outage), and the user may reconnect with new online connection and/or containerized application. This reconnection may occur before an offline request for the previous connection. The connection ID can be used to provide accurate tracking, with a new connection ID remaining in the data set, while the previous data set corresponding to the previous connection ID expires. The communication system can use the data set 222 to detect whether a user is online or not. As such, in some embodiments, instructions are executed can cause a connect of the second user with a different third containerized application (e.g., third containerized application 202c), which is different than the previous containerized application (e.g., second containerized application 202d), upon reestablishing an online connection, with the third containerized application 202c being assigned to be in communication with the user (e.g., second user 110b) for the previously active conversation ID with which the second user was previously associated. The third containerized application 202c can determine, in response to receiving a subsequent data segment 208 from the appended data stream 210, that the third containerized application 202c is associated with the first conversation ID and assigned to forward messages of the first conversation based on the first conversation ID to the second user 110b. The containerized application can control the transceiver to cause the transmission, via the distributed communications network, the subsequent message to the second user 110b in response to the third containerized application 202c identifying that the third containerized application is assigned to relay communications with the second user for the first conversation ID.

In some embodiments, the network service 320 and/or containerized applications 202 can control the transceiver 107 to communicate a status confirmation request 610 and/or connection status request to a user device associated with the second user 110b. This status request can be initiated periodically, based on a tracking duration threshold timing, initiated based on a request from another system component, and/or initiated based on other such activations. For example, in some embodiments, a status confirmation request 610 or other such ping can be communicated to the user device in response to identifying that a tracking duration threshold duration has expired (e.g., “Y” seconds) since an online confirmation that the user is online and/or since a most recent communication, which may have been a previous response to a status request, a user initiated message, etc. When a response 612 to the status request is received, the network service 320 can provide the online status update 604 to the adapter application 214, which can update and/or generate a new online status data 606 updating the data set 222. As such, the network service 320 can in some implementations periodically updated the online status when the client responds to a request or ping message (e.g., every 10 seconds, every 15 seconds, etc.). If the client does not respond within a threshold duration (e.g., the TTL timeframe), in some instances the user's presence is considered expired, and they can be treated as “offline”. As such, the processing resource 102 can identify that a tracking duration threshold has expired since a confirmation that the second user is online, and thus an online confirmation response is not received within the threshold duration from the communication of the confirmation request.

A user 110 can, in some instances, terminate an online connection and/or a conversation. As such, in some embodiments, the network service 320 can receive a disconnect notification 614. In response to the disconnect, the network service can provide an “offline” request or notification 616 to the adapter application 214, which in turn can trigger 618 a removal of the user entry from the data set 222 (e.g., delete instruction to delete a connection ID for that user in the Redis set). Some embodiments return an acknowledgement 620.

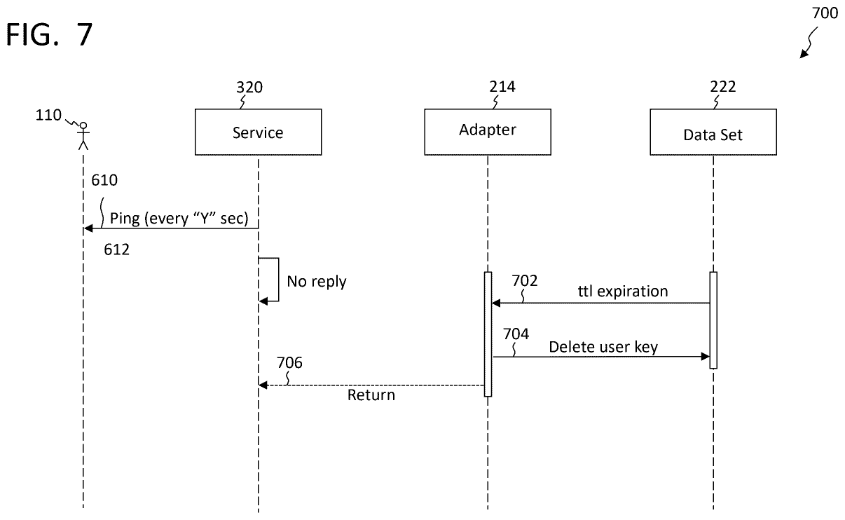

FIG. 7 illustrates a simplified functional diagram of an example connection tracking process 700, in accordance with some embodiments. As described above, in some embodiments, the network service 320 and/or adapter application 214 can communicate an online status confirmation request 610 to the user 110. When no reply is received, an update to the data set is not generated. The data set 222 and/or the adapter application 214 can identify 702 that a threshold period of time has lapsed indicating an expiration of an online status. The adapter application 214 can request a removal 704 of the user entry from the data set 222 (e.g., delete instruction to delete a user key (with a same connection ID) in the Redis set). Some embodiments return an acknowledgement 706.

As such, in some embodiments, the communication system 100 can detect user presence and handle offline users. In some embodiments, the user presence detection mechanism improves scalability while increasing system efficiency. A data set (e.g., Redis set) can be used in part to track the presence of each user client, such as based on a TTL. When a connection (e.g., websocket connection) is established, the system can mark a user as online (e.g., in Redis set) relative to a designated threshold period of time (e.g., 20 seconds). The online status can be periodically updated, such as in response to receiving a subsequent communication from the user, when the client responds to a status confirmation request 610 or ping message sent by the server, and/or other instances. The status request can, in some embodiments, be communicated at regular intervals (e.g., every 15 seconds). When a user 110 does not respond within a threshold (e.g., a TTL timeframe), the online presence of the user is considered expired, and the user can be treated as offline. A such, in some embodiments, a user can be designated offline based on identifying that an online confirmation response is not received within a second threshold duration from the communication of the status confirmation request 610.

When a user is offline (e.g., due to TTL expiration, disconnection, etc.), messages received in a conversation and intended for the offline user may not be appended to the appended data stream 210 (e.g., when the offline user is the only intended recipient). In other instances, the message may be appended to the appended data stream when one or more additional users are intended to receive the message. Further, in some embodiments, when a user is determined to be offline and a message is received, the system may utilize one or more notification services 224 to handle offline messages. These messages may be sent to the notification service 224 to be send as one or more push notifications to the user. This enables user to receive timely updates even when the user is disconnected. The cooperation of the data set 222 and notification service 224 can provide mechanisms to ensure messages are delivered to active users connected to the communication system 100, while offline users are intelligently handled via the notification service (e.g., substantially any notification service and/or other such communications management solution). Alternatively or additionally, one or more messages may be retained in a message database. If a user is subsequently reconnected, such as within an offline threshold period of time, one or more of the saved messages may be forwarded to the corresponding containerized application to be forwarded to the user. Some embodiments provide further optimization to reduce a number of calls to the adapter application 214 by grouping messages and/or events for a predefined collection threshold period of time (e.g., 0.5 seconds, 1 second, 2 seconds, or other relevant duration) in one request.

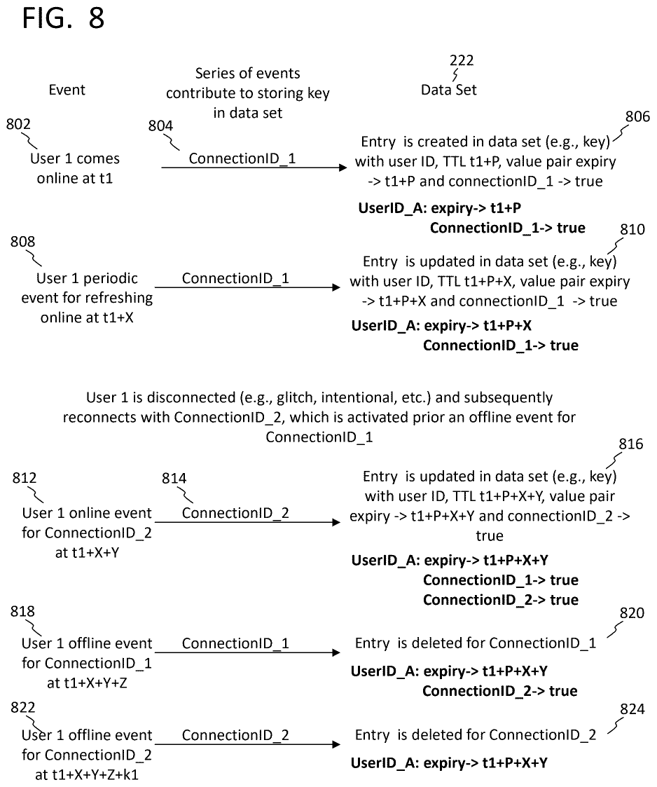

FIG. 8 illustrates an example timeline representation of managing connection IDs, in accordance with some embodiments. In response to a user coming online 802 at time “t1”, a first connection ID 804 (ConnectionID_1) is generated in cooperation with the UserID_A, and in some instances with conversation ID. The data set 222 is updated 806 with an entry key with the user ID, a designated threshold (e.g., relative to the time (t1), of t1+P) with a value connectionID_1 of true or active. One or more refresh events 808 can occur over time relative to the ConnectionID_1, such as a first refresh at time t1+x. At each update, the data set can be updated 810 relative to the user ID and ConnectionID_1 with an expiration corresponding to t1+P+X, and a value for ConnectionID_1 of true. Following a disconnect of the user 1, and prior to an expiration of ConnectionID_1, the user 1 may re-establish a different connection 812 (e.g., with a different containerized application). A second connection ID can be established 814 (ConnectionID_2) at time t1+X+Y, with the data set updated 816 corresponding to the user ID and ConnectionID_2, with an expiration of t1+P+X+Y, where both the ConnectionID_1 and ConnectionID_2 are true. At some time t1+X+Y+Z the ConnectionID_1 can be terminated 818, and the data set updated to delete 820 the entry key corresponding to the ConnectionID_1, with ConnectionID_2 true and the expiration of t1+P+X+Y. At some later time t1+X+Y+Z+k1, an offline event for ConnectID_2 can be detected 822, with the data set updated 824 to delete the entry corresponding to ConnectionID_2, at least by the expiration t1+P+X+Y. In some embodiments, this key is automatically deleted by the ttl expiry after a t1+P+X+Y time.

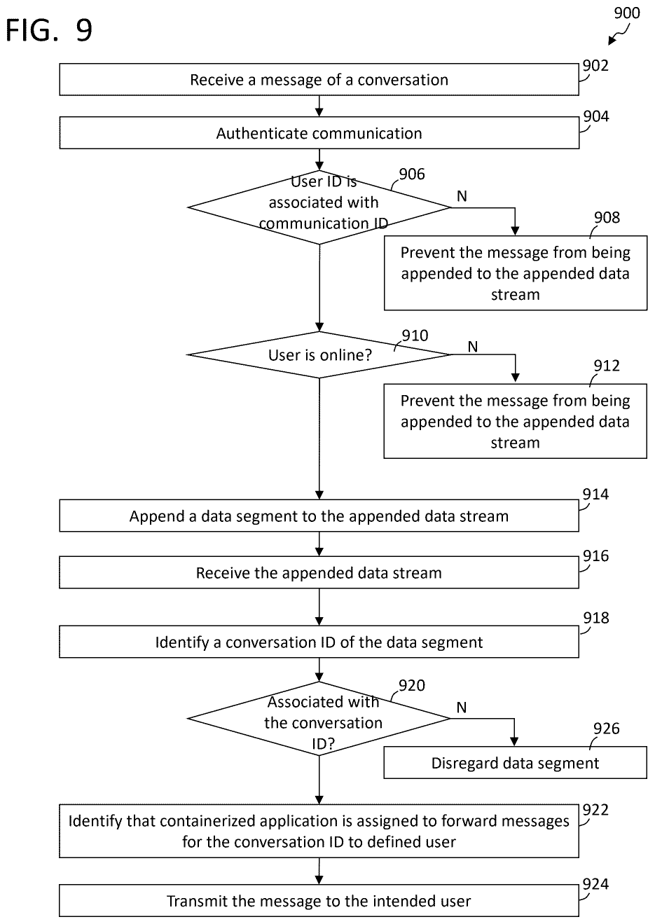

FIG. 9 illustrates a flow diagram of an example process 900 of controlling communications, in accordance with some embodiments. In step 902, a message of a first conversation between a first user 110a and a second user 110b is received from the first user via the distributed communications network 101 through a first containerized application 202a of multiple active containerized applications 202. Some embodiments optionally implement an authentication on the message received in step 904. In step 906, it is determined whether the first and/or second users are associated with the first conversation. In some embodiments, the adapter application 214 can optionally access a database 108, table, listing, data set or other information to confirm that a first user ID related to the first user is associated with a first conversation ID. In step 908, the process 900 can prevent the message from being appended to the appended data stream 210 when it is determined that the first user is not associated with the first conversation. For example, a message can be received from a user, through one of the containerized applications 202 and includes a designation indicating the message is associated with the first conversation ID, and a user ID. This message can be prevented from being appended to the appended data stream 210 in response to determining that the user ID is not associated with the corresponding identified conversation ID.

In step 910, some embodiments determine whether the intended recipient second user 110b is online and/or actively participating in the conversation. When the second user is determined to be offline and/or not actively participating in the conversation, some embodiments advance to step 912 where the message can be stored in a database 108. When the second user is determined to still be online, a first data segment 208 that includes at least a portion of the message is appended to the appended data stream 210 in response to receiving the message of the first conversation. As described above, data segments 208 of the appended data stream 210 can include data segments of multiple different conversations, which can be sequentially appended over time. The first data segment can in some embodiments comprise the first conversation identifier (ID) corresponding to the first conversation, and the first message. Further, in some implementations, the data segments 208 can include the user IDs of the sending and/or one or more receiving users. The appended data stream 210 is communicated, in some embodiments, to each of the active containerized applications 202.

In step 914, the first data segment of the appended data stream 210 is received at a second containerized application, which may be the same containerized application that received the first message or a different second containerized application. In step 916, the appended data stream 210 is received at each of the multiple active containerized applications 202 to receive over time each of the sequential data segments 208 of the multiple different conversations from the appended data stream. Some embodiments include step 918 where at least a conversation ID is identified from the first data segment. In step 920, the second containerized application 202d can determine, in response to receiving the first data segment, whether the second containerized application is associated with the first conversation ID. In step 922, a second containerized application 202d can identify that the second containerized application is previously assigned to forward messages of the first conversation to the second user based in part on the first conversation ID. In step 924, the second containerized application causes the transceiver 107 to transmit, via the distributed communications network 101, at least the first message to the second user 110b in response to the second containerized application identifying that the second containerized application is assigned to relay communications with the second user for the first conversation ID.

Some embodiments, in response to a containerized application determine in step 920, that the containerized application is not associated with the conversation ID, the process 900 can advance to step 926 where the one or more of the containerized applications 202 disregard the first data segment. For example, in some embodiments, each of the multiple active containerized applications 202 receiving the appended data stream 210 can identify, for each data segment 208 of the appended data stream 210, a respective conversation ID, and may disregard each data segment of the appended data stream for which the corresponding containerized application has not been associated with the respective conversation ID.

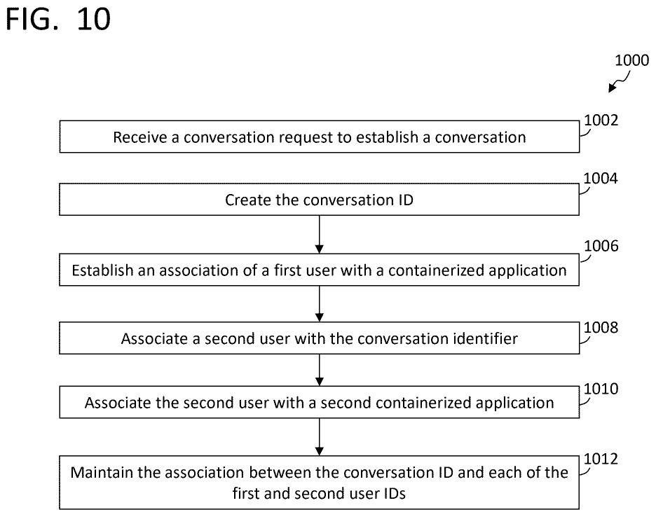

FIG. 10 illustrates a flow diagram of an example process 1000 of establishing a conversation, in accordance with some embodiments. In step 1002, a conversation API call to create a conversation can be received from a user (e.g., a first user 110a). This request to establish a communication can be received prior to or along with receiving a first message that is intended to be communicated to a second user 110b that is to participate in the conversation. In step 1004, a conversation ID can be created that is exclusively associated with the first conversation. In some embodiments, a unique code or identification is provided with the API call (e.g., an invoice number, one or more user IDs, other such information, or a combination of two or more of such information) that may be used in creating the conversation ID. Further, one or more connection IDs may additionally be created relative to an active network connect of the first user and/or one or more other users of the conversation with the conversation system 100. In step 1006, an association of the first user is established with one of the containerized applications 202 (e.g., a first containerized application 202a) in response to the conversation request. In some embodiments, a link, URL (e.g., websocket URL) and/or other such content that is utilized by the user device in connecting with the containerized application 202. The first containerized application 202a may be an already active containerized application or be activated based in part on the conversation request. For example, the network service 320, the adapter application 214 and/or a load tracking application executed by the processing resource can evaluate a number of users and/or number of conversations being actively supported, a predicted load based on historic information, data quantities being and/or predicted to be communicated, other such information or a combination of two or more of such information.

In step 1008, the second user 110b is further associated with the conversation identifier. In step 1010, the second user is associated with a containerized application 202 for the first conversation. For example, the second user may be associated with a second containerized application 202d, which is different than the containerized application that the first user is associated. However, in some instances, the second user may be associated with the same containerized application with which the first user is associated for the first conversation.

In step 1012, the association between the first conversation ID and each of the first user ID and one or more other users of the first conversation, including the second user ID, is maintained within a conversation database 108, table, data set, and/or other relevant data storage.

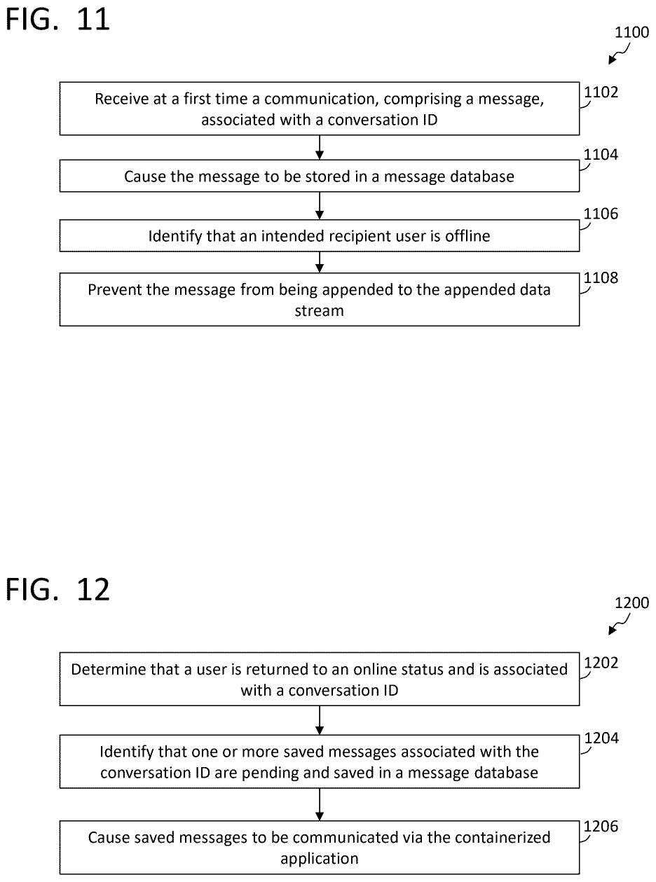

FIG. 11 illustrates a flow diagram of an example process 1100 to tracking user status in participating in the conversation, which may include determining whether a user is on or offline with the communication system 100, in accordance with some embodiments. In step 1102, a communication is received at a first time via a first containerized application 202a from a first user 110a. The communication can comprise a message, and a designation indicating the message is associated with a particular conversation ID. The communication may further include one or more user IDs, such as the sending user ID and/or one or more intended recipient user IDs corresponding to intended recipient users of the communication session.

In step 1104, the processing resource 102 can cause the message to be stored in a database 108 (e.g., a message database) in association with the respective conversation ID. In step 1106, the process 1100 can identify that an intended recipient second user 110b is not actively participating in the communication and is thus considered offline at least relative to the current communication session. For example, a user has disconnected from a communication session, the user device is inadvertently disconnected (e.g., a network problem, problem with the user device, etc.), and/or other such issues. In step 1108, the message is at least temporarily prevented from being appended to the appended data stream 210 in response to identifying that the second user is offline.

FIG. 12 illustrates a flow diagram of an example process 1200 to communicate stored messages to a user upon the user reestablishing an online connection status enabling active continued participation in the conversation, in accordance with some embodiments. In step 1202, it can be determined, at a second time that is subsequent in time to a first time when a user was previously determined offline and/or was not actively participating, that the second user 110b is online and is associated with a first conversation ID. In step 1204, it is identified that one or more saved messages associated with the first conversation ID are pending and saved in a database 108 (e.g., a message database). The one or more saved messages comprise at least one previous message received while the second user was determined to be offline, and in some instances may comprise two or more message received and saved. In some embodiments, the user device may identify which messages of the conversation were previously received and/or a most recent message that was received. Based on the identification of the one or more messages previously received, it can be determined whether one or more additional messages have been stored. In step 1206, the identified messages that were saved and not previously received by the user device can be compiled and provided to the assigned containerized application 202 that can forward the one or more saved messages. In some embodiments, one or more communications of the saved messages can comprise the one or more saved messages and the conversation ID, and in some instances one or more user IDs of one or more intended recipient users and/or the sending user.

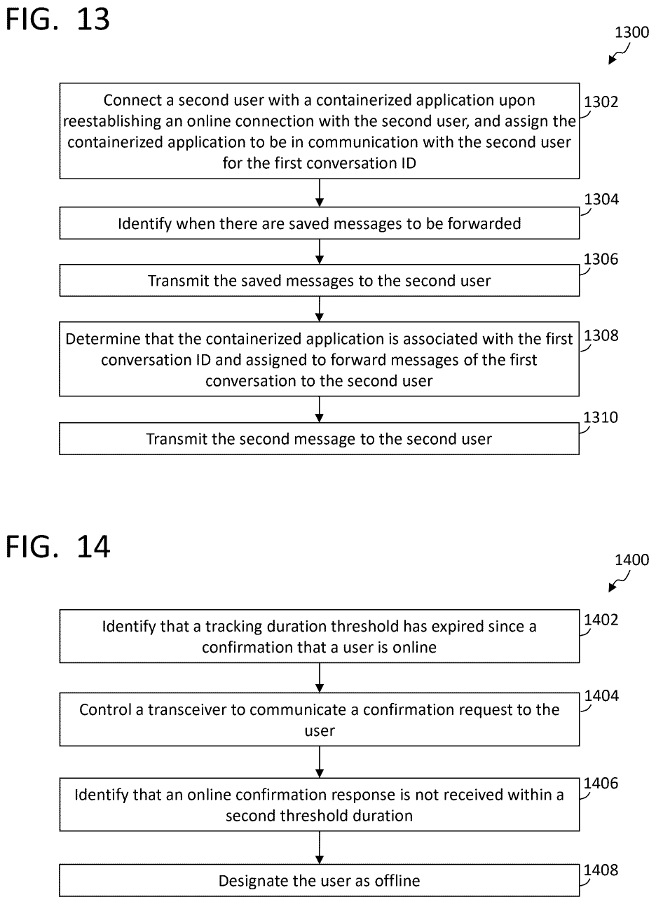

FIG. 13 illustrates a flow diagram of an example process 1300 of connecting a user to a different containerized application upon reestablishing a connection and/or online status to a particular conversation after having been disconnected from the conversation, in accordance with some embodiments. In step 1302, the second user is connected with a third containerized application (e.g., containerized application 202c), which may be different than the containerized application the second user was previously associated with, upon reestablishing an online connection with the second user, and the third containerized application is assigned to be in communication with the second user for the first conversation ID. In step 1304, the third containerized application 202c may initiate a query to determine whether there are one or more saved messages to be communicated to the user device. In optional step 1306, saved messaged can be identified and forwarded via the third containerized application to the user device. In step 1308, the third containerized application 202c, in response to receiving a data segment from the appended data stream 210, determines that the third containerized application is associated with the first conversation ID and assigned to forward messages of the first conversation to the second user. In step 1310, the second message is transmitted, via the distributed communications network 101, to the second user in response to the third containerized application 202c identifying that the third containerized application is assigned to relay communications with the second user for the first conversation ID.

FIG. 14 illustrates a flow diagram of an example process 1400 of attempting to confirm an online status of a user, in accordance with some embodiments. In step 1402, it is identified that a tracking duration threshold has expired since a previous confirmation that the user is online. In step 1404, a transceiver 107 is controlled to communicate, via the communications network 101, a status confirmation request 610 to the user. In step 1406, it can be identified that an online confirmation response is not received within a second threshold duration from the communication of the confirmation request. In step 1408, the user is designated offline and/or inactive relative to the communication session. In some embodiments, a data set 222 is updated to remote an entry (e.g., a key in a Revis set) in response to determining that the user is offline and/or otherwise inactive.

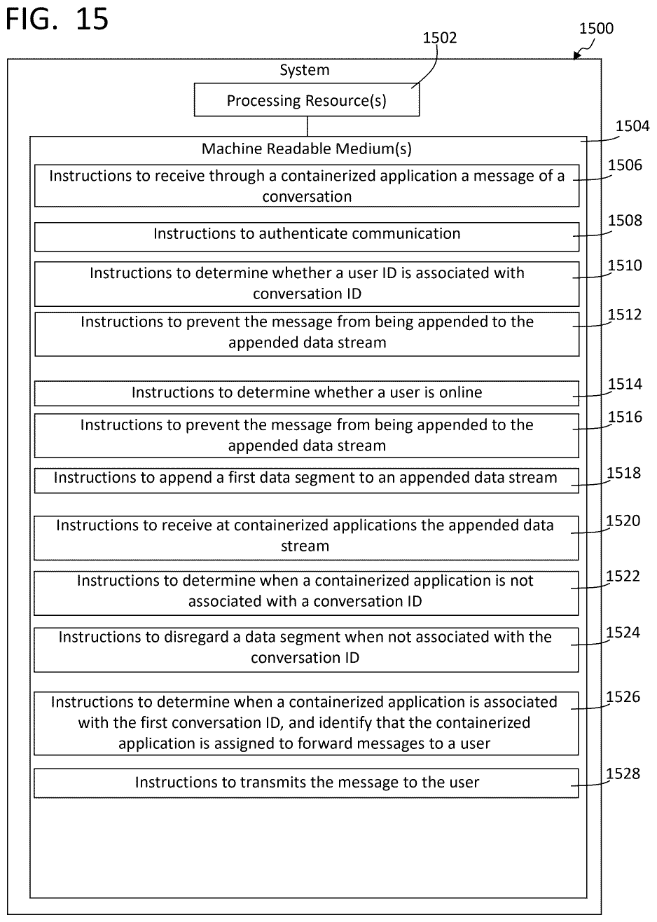

FIG. 15 depicts example system 1500 that includes one or more non-transitory, machine readable media 1504 encoded with example instructions executable by one or more processing resources 1502, in accordance with some embodiments. In some embodiments, the system 1500 may be useful for implementing aspects of the communication system 100 and/or the one or more processing resources 102, and/or in performing some or all aspects of the processes 900, 1000, 1100, 1200, 1300 and/or 1400 of FIGS. 9-14, respectively. For example, the instructions encoded on machine readable media 1504 may be included in instructions 106. In some implementations, functionality described with respect to FIGS. 1-8 may be included in the instructions encoded on machine readable media 1504. The one or more processing resources 1502 may include one or more microcontrollers, one or more microprocessors, one or more central processing unit cores, one or more ASICs, one or more FPGAs, other hardware device suitable for retrieval and/or execution of instructions from the machine readable media 1504 to perform functions related to various examples, or a combination of two or more of such devices. Additionally or alternatively, the processing resources 1502 may include or be coupled to electronic circuitry or dedicated logic for performing some or all of the functionality of the instructions described herein.

The machine readable media 1504 may be any one or more medium suitable for storing executable instructions, such as RAM, ROM, EEPROM, flash memory, a hard disk drive, an optical disc, or the like. In some example implementations, the machine readable media 1504 may be a tangible, non-transitory medium. The machine readable media 1504 may be disposed within the system 1500, in which case the executable instructions may be deemed installed or embedded on the system. Additionally or alternatively, some or all of the machine readable media 1504 may be one or more remote, external to and/or portable storage medium, and may be part of an installation package.

As described further herein, the machine readable media 1504 may be encoded with one or more sets of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 15.

With reference to FIG. 15, the machine readable media 1504 includes instructions 1506, 1508, 1510, 1512, 1514, 1516, 1518, 1520, 1522, 1524, 1526, and 1528. Instructions 1506, when executed, cause the processing resource 102 to receive, from a first user 110a via a distributed communications network 101 through a first containerized application 202a of multiple active containerized applications 202, a first message of a first conversation between the first user and at least a second user 110b. Instructions 1508, when executed, cause the processing resource 102 to authenticate the first user. Some embodiments route relevant information as an authentication request to an authentication system 206 that can process information, such as the user ID, a user device identifier, conversation ID, network information, encryption information, security token(s), other such information or a combination of two or more of such information. An authentication 306 can be returned in response to the first user being authenticated. In other instances when the first user is not authenticated the processing resource may disregard the message, notify the first user, log the lack of authentication, activate one or more fraud actions, other such actions or a combination of two or more of such actions. Instructions 1510, when executed, can cause the processing resource to determine whether a user ID of the first user and/or second user is associated with the conversation ID corresponding to the current conversation. Instructions 1512, when executed, can cause the processing resource to prevent the message from being appended to the appended data stream 210 when it is determined that the first user is not associated with the first conversation.

Instructions 1514, when executed, can cause the processing resource to determines that the intended recipient second user is online and is associated with the first conversation ID. Instructions 1516, when executed, can cause the processing resource to cause the message to be stored in a database 108 in association with the first conversation ID in response to identify that the second user is offline, and at least temporarily preventing the second message from being appended to the appended data stream 210. Instructions 1518, when executed, can cause the processing resource to append, in response to receiving the first message of the first conversation, a first data segment 208 to the appended data stream 210 to which each data segment of multiple different conversations is sequentially appended over time. The first data segment can comprise a respective conversation ID corresponding to the active conversation and the message received from the first user 110a. Instructions 1520, when executed, can cause the processing resource to receive at each of the multiple active containerized applications 202 the appended data stream 210 over time to receive each of sequential data segments 208 of the multiple different conversations from the appended data stream. Instructions 1522, when executed, can cause the processing resource to determine, at one or more containerized applications in response to receiving a first data segment from the appended data stream, that the one or more containerized application are not associated with the first conversation ID. Instructions 1524, when executed, can cause the processing resource to disregard the first data segment in response to the respective containerized application determining that the respective containerized application is not associated with the first conversation ID.

Instructions 1526, when executed, can cause the processing resource to determine, in response to receiving a first data segment at a containerized application 202a from the appended data stream 210, that the containerized application is associated with the first conversation ID, and identify, based on the first conversation ID, that the respective containerized application is previously assigned to forward messages of the first conversation to an intended recipient user (e.g., user 110b). Instructions 1528, when executed, cause the processing resource to transmit, via the distributed communications network 101, the first message to the intended recipient user 110b in response to the respective containerized application identifying that the respective containerized application is assigned to relay communications with the intended recipient user for the first conversation ID.

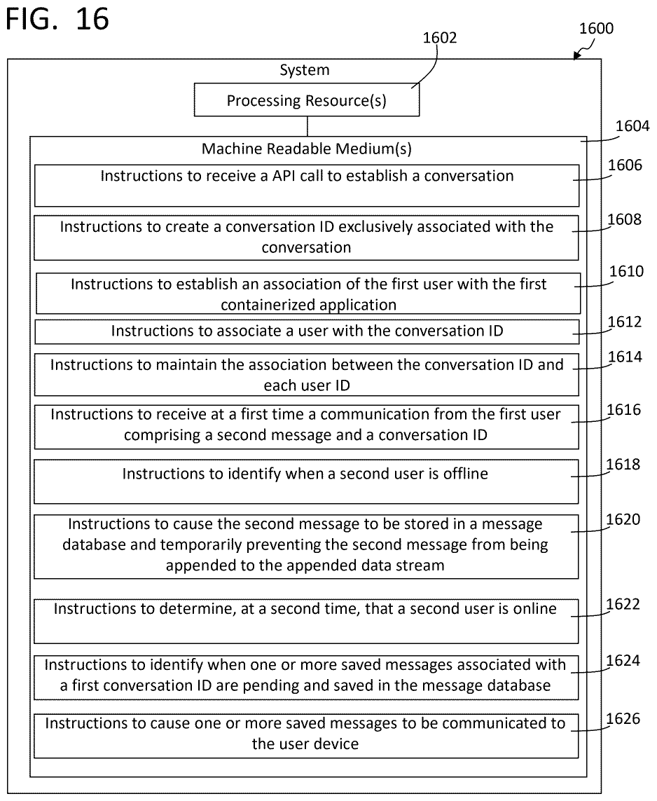

FIG. 16 depicts example system 1600 that includes one or more non-transitory, machine readable media 1604 encoded with example instructions executable by one or more processing resources 1602, in accordance with some embodiments. Instructions 1606, when executed, cause the processing resource to receive, from a first user 110a and prior to receiving a first message, a conversation API call or request to establish a conversation. In some implementations, the API call is directed to a containerized application 202. Instructions 1608, when executed, cause the processing resource to create a first conversation ID exclusively associated with the first conversation. A link, URL (e.g., websocket URL) and/or other such information can be communicated to the user device for subsequent use in establishing the conversation connection (e.g., submitting websocket URL connection request) with the containerized application 202. In some embodiments, each user of a conversation similarly establish a connection with a respective containerized application. When a user device submits a conversation API call, a unique identifier can be included that can be used to generate a conversation ID. This same unique identifier from any user can similarly be used to generate the same conversation ID, enabling the linking of two or more users to the same conversation associated with that conversation ID. For example, a unique identifier may be a combination of a first user ID and a second user ID, an order identifier, invoice identifier, and/or other relevant unique identifier.

Instructions 1610, when executed, cause the processing resource to establish, in response to the conversation API request, an association of the first user with a first containerized application 202a. Instructions 1612, when executed, cause the processing resource to associate a second user 110b with the conversation identifier. Instructions 1614, when executed, cause the processing resource to maintain, within one or more databases (e.g., a conversation database), the association between the first conversation ID and each of the one or more users participating in the first conversation (e.g., first user ID and the second user ID).

Instructions 1616, when executed, cause the processing resource to receive at a first time a communication, via the first containerized application 202a, from the first user 110a, with the communication comprising a second message, and a designation indicating the second message is associated with the first conversation ID. Instructions 1618, when executed, cause the processing resource to identify that the second user is offline. Instructions 1620, when executed, cause the processing resource to cause the second message to be stored in a database 108 in association with the first conversation ID, and at least temporarily preventing the second message from being appended to the appended data stream 210 in response to identifying that the second user is offline. Instructions 1622, when executed, cause the processing resource to determine, at a second time that is subsequent in time to the first time, that the second user is again online and is associated with the first conversation ID. Instructions 1624, when executed, cause the processing resource to identify that one or more saved messages, including the second message, associated with the first conversation ID are pending and saved in a database (e.g., a message database). Instructions 1626, when executed, cause the processing resource to cause one or more saved messages not previously provided to the second user to be forwarded to the containerized application 202a that forwards the one or more saved messages.

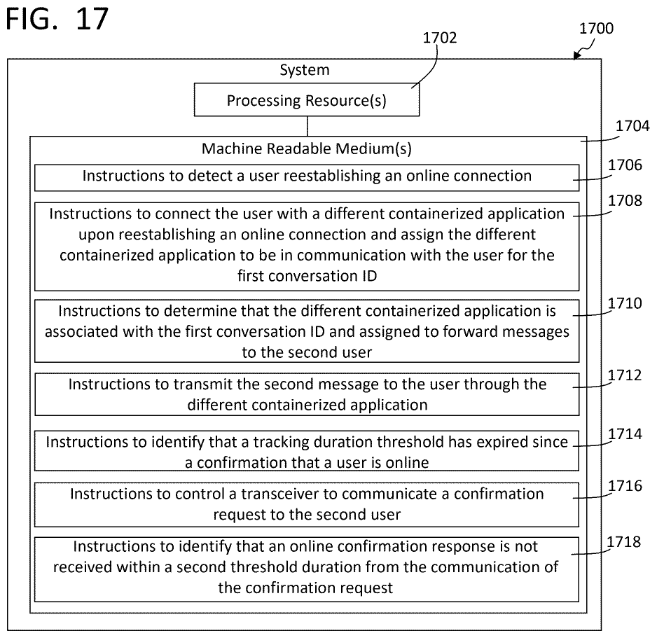

FIG. 17 depicts example system 1700 that includes one or more non-transitory, machine readable media 1704 encoded with example instructions executable by one or more processing resources 1702, in accordance with some embodiments. Instructions 1706, when executed, cause the processing resource to detect a user is reestablishing an online connection. Instructions 1708, when executed, cause the processing resource to connect a second user 110b with a third containerized application, which may be different than a containerized application with which the second user was previously associated, upon reestablishing an online connection with the second user. The instructions 1708 can further cause the third containerized application 202c to be assigned to be in communication with the second user for the first conversation ID. Instructions 1710, when executed, cause the processing resource to determine, in response to receiving the second data segment from the appended data stream 210, that the third containerized application 202c is associated with the first conversation ID and assigned to forward messages of the first conversation to the second user. Instructions 1712, when executed, cause the processing resource to transmit, via the distributed communications network 101 from the third containerized application 202c, the second message to the second user in response to the third containerized application identifying that the third containerized application is assigned to relay communications with the second user for the first conversation ID.

Instructions 1714, when executed, cause the processing resource to identify that a tracking duration threshold has expired since a confirmation that a user is online. Instructions 1716, when executed, cause the processing resource to control a transceiver 107 to communicate, via the communications network, a confirmation request to the second user. Instructions 1718, when executed, cause the processing resource to identify that an online confirmation response is not received within a second threshold duration from the communication of the confirmation request.

Similar to the system 1500, the systems 1600 and 1700 may be useful for implementing aspects of the communication system 100 and/or the one or more processing resources 102, and/or in performing some or all aspects of the processes 900, 1000, 1100, 1200, 1300 and/or 1400 of FIGS. 9-14, respectively. In some implementations, some of functionality described with respect to FIGS. 1-8 may be included in the instructions encoded on machine readable mediums 1604 and/or 1704. The one or more processing resources 1602 and/or 1702 may include one or more microcontrollers, one or more microprocessors, one or more central processing unit cores, one or more ASICs, one or more FPGAs, other hardware device suitable for retrieval and/or execution of instructions from the machine readable media 1604 and/or 1704 to perform functions related to various examples, or a combination of two or more of such devices. Additionally or alternatively, the processing resources 1602 and/or 1702 may include or be coupled to electronic circuitry or dedicated logic for performing some or all of the functionality of the instructions described herein.

The machine readable mediums 1604 and/or 1704 may be any one or more medium suitable for storing executable instructions, such as RAM, ROM, EEPROM, flash memory, a hard disk drive, an optical disc, or the like. In some example implementations, the machine readable mediums 1604 and/or 1704 may be a tangible, non-transitory medium. The machine readable mediums 1604 and/or 1704 may be disposed within the systems 1600 and/or 1700, in which case the executable instructions may be deemed installed or embedded on the system. Additionally or alternatively, some or all of the machine readable mediums 1604 and/or 1704 may be one or more remote, external to and/or portable storage medium, and may be part of an installation package.

As described further herein, the machine readable mediums 1604 and/or 1704 may be encoded with one or more sets of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 15-17.

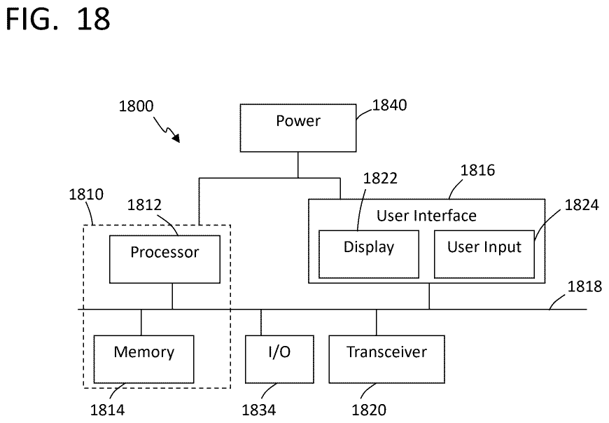

Further, the circuits, circuitry, systems, devices, processes, methods, techniques, functionality, services, servers, sources and the like described herein may be utilized, implemented and/or run on many different types of devices and/or systems. FIG. 18 illustrates an example system 1800 that may be used for implementing any of the components, processing resources, circuits, circuitry, systems, functionality, logic, apparatuses, processes, and/or devices of the communication system 100, user devices, processing resources 102, authentication systems 206, adapter application 214, and/or other above or below mentioned systems or devices, or parts of such circuits, circuitry, functionality, systems, apparatuses, processes, or devices. However, the use of the system 1800 or any portion thereof is certainly not required.

By way of example, the system 1800 may comprise one or more processor resources 1812 (sometimes referred to as control circuits), one or more memory 1814, and one or more communication links, paths, buses or the like 1818. Some embodiments may include one or more user interfaces 1816, and/or one or more internal and/or external power sources or supplies 1840. The control circuit 1812 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1812 can be part of control circuitry and/or a control system 1810, which may be implemented through one or more processors with access to one or more memory 1814 that can store instructions, code and the like that is executed and/or implemented by the control circuit and/or processors to implement intended functionality. In some applications, the control circuit and/or memory may be distributed over a communications network 101 (e.g., LAN, WAN, Internet, cellular, etc.) providing distributed and/or redundant processing and functionality. Again, the system 1800 may be used to implement one or more of the above or below, or parts of, components, circuits, systems, processes and the like.

The user interface 1816 can allow a user to interact with the system 1800 and receive information through the system. In some instances, the user interface 1816 includes a display 1822 and/or one or more user inputs 1824, such as buttons, touch screen, track ball, keyboard, mouse, etc., which can be part of or wired or wirelessly coupled with the system 1800. The system 1800 can further include one or more communication interfaces, ports, transceivers 1820 and the like allowing the system 1800 to communicate over a communication bus, a distributed computer and/or communication network 101 (e.g., a local area network (LAN), the Internet, wide area network (WAN), cellular, Bluetooth, Wi-Fi, etc.), communication link 1818, other networks or communication channels with other devices and/or other such communications or combination of two or more of such communication methods. Further the transceiver 1820 can provide wired, wireless (e.g., cellular, Bluetooth, Wi-Fi, satellite, other such wireless communication or a combination of two or more of such wireless communication), optical, fiber optical cable, other such communication configurations or combinations of two or more of such communications. Some embodiments include one or more input/output (I/O) ports 1834 that allow one or more devices to couple with the system 1800. The I/O ports can be substantially any relevant port or combinations of ports, such as but not limited to USB, Ethernet, or other such ports. The I/O interface 1834 can allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

The system 1800 comprises an example of a control and/or processor-based system with the control circuit 1812. Again, the control circuit 1812 can be implemented through one or more processors, controllers, central processing units, logic, software and the like. Further, in some implementations the control circuit 1812 may provide multiprocessor functionality.

The memory 1814, which can be accessed by the control circuit 1812, can include one or more processor-readable and/or computer-readable media accessed by at least the control circuit 1812, and can include volatile and/or nonvolatile media, such as RAM, ROM, EEPROM, flash memory and/or other memory technology. Further, the memory 1814 is shown as internal to the control system 1810; however, the memory 1814 can be internal, external or a combination of internal and external memory. Similarly, some or all of the memory 1814 can be internal, external or a combination of internal and external memory of the control circuit 1812. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 101. The memory 1814 can store code, software, executables, scripts, data, content, lists, programming, programs, log or history data, user information, customer information, product information, and the like. While FIG. 18 illustrates the various components being coupled together via a bus, it is understood that the various components may actually be coupled to the control circuit and/or one or more other components directly. network

In some embodiments, the communication system 100 can leverage one or more appending queue processes (e.g., Redis streams) to provide dynamic and scalable message routing across multiple containerized applications (e.g., Kubernetes pods), in establishing low-latency, real-time communication even in distributed environments. Further, the communication system in some embodiments enables self-hosting within system infrastructures, offering complete control over scalability, customization, and resource optimization. Further, the conversation system 100 can utilize in some embodiments one or more websocket servers that can handle cross-containerized application message routing, manage user presence detection, manage and/or track user online/offline status and management, and provide an efficient, reliable, and fully customizable solution for real-time communications in large-scale, distributed systems. The communication system 100 can incorporate one or more websocket servers while providing the real-time communication through a queue system (e.g., Redis streams) enabling cross-containerized application message routing. The communication system scales horizontally and achieves low-latency, real-time communications while tracking client presence in a highly dynamic and distributed setup. Some embodiments utilize websocket clients, while in some instances removing the need for proprietary libraries.

Communications and/or requests, whether initiating a new conversation (createConversation) and/or upgrading to a websocket connection, can initially be authenticated and/or authorized to ensure security. The communication system can be integrated within and/or use known authentication platforms and/or systems. In some embodiments, a communications and/or requests to create a conversation can specify one or more users authenticated and/or authorized to join the conversation. These users can be validated through the authentication systems 206, and can in some embodiments be validated prior to further actions being implemented and/or allowed. The authentication system 206 can in some implementations verify identities and/or roles of the requesting user and/or other users intended to be part of the conversation. Following authentication and/or while a conversation is active, the system can ensure that users specified as part of the conversation (e.g., specified in a createConversation body) are allowed to join and/or participate in the conversation. In some embodiments, when a user initiates a conversation (e.g., via a createConversation API), a new conversation ID can be generated or a previously generated conversation ID can be generated that is generated based on identifying information, and a list of authenticated users can be stored securely in a database 108. This enables toe system to identify which users are allowed to connect to a conversation (e.g., a websocket). Some embodiments provide access (e.g., a link, URL (e.g., websocket URL) and/or other such access) to a conversation to one or more users authenticated and/or authorized to participate in sending and/or receiving messages of the conversation. The user can participate in and/or cause a conversation to be initiated utilizing the access (e.g., conversation URL).

The communication system 100 can utilize a queue process and/or system (e.g., one or more Redis streams) in part to enable efficient, horizontal scaling and real-time message delivery. When a user sends a message, it is processed by the adapter application 214. Further, in some embodiments, the adapter application 214 can determine whether an intended recipient user is actively participating in the conversation and considered online by checking the user's online presence status maintained in a table, data set 222 or the like (e.g., Redis set). When the user is determined to be online, the adapter application 214 can incorporate the message into a data segment 208 that is publish to the queued appended data stream 210 (e.g., Redis stream). The appended data stream 210 can operate as a message queue that enables the distribution of messages of multiple different conversations to the multiple active containerized applications 202. Each containerized application 202 subscribes to the appended data stream queue and evaluates each data segment 208 to identify those data segments related to the conversation IDs for which the respective containerized application is associated and handling. The data segments, and thus the messages, are published to the appended data stream 210, that routes the data segments across to each of the active containerized applications 202. This distribution ensures that the correct containerized application, which has the user (e.g., connected via a websocket), delivers the message to the intended user. As such, some embodiments eliminate a need for direct containerized application addressing and allows for the dynamic scaling of the system while maintaining reliable message delivery, and efficient routing across multiple containerized applications and users without overloading individual containerized applications, even as the communication system 100 scales horizontally. Some embodiments can further implement some optimization to limit a number of calls to the adapter application 214 by grouping messages and/or events during a grouping threshold period of time (e.g., 1 second, 1.5 seconds, 2 seconds, etc.) into one data segment 208 or request.

The communication system 100 can in some embodiments utilize the user active and/or online presence detection mechanism to enhance the scalability and efficiency of the system. A data set, table, Redis set, and/or other such records system can be used to maintain the tracked presence status of each user participating in and/or associated with a conversation. Further, some embodiments employ one or more duration thresholds as a basis for determining presence status of the user (e.g., based on a Time-to-Live (TTL) mechanism). When a connection is established (e.g., websocket connection), the communication system can mark a user as active or online in the data set 222. The active status can be maintained for a period of time (e.g., approximately 20 seconds), and the active status can periodically be updated based on subsequent communications and/or when a user device or user responds to a status request or ping message, which may be sent by the network service 320 and in some embodiments can be sent at regular intervals (e.g., every 3 seconds, every 15 seconds, every 20 seconds, and/or other relevant interval, which may be dependent on one or more factors such as but not limited to bandwidth, number of active conversations, number of users participating in a conversation, a priority level of a conversation, other such factors, or a combination of two or more of such factors). When a user does not respond within the threshold timeframe (e.g., TTL), the presence status can be considered expired, and that user can be treated as offline. One or more data sets 222 can be used to store markings of users online/offline status. For example, the data set can store one or more keys which can be based on a respective conversation ID and/or other domain configuration. A default value can be set for new key creation. Further, some embodiments assign a connection ID for each user connection that can be maintained in relation to the conversation ID with which the connection corresponds. The connection ID can in some implementations be stored in a set of the data set 222, and can further include an expiration time and/or duration. During an offline status, a corresponding connection ID can be removed from the data set. This removal of the connection ID enables the system to reconnect a user, such as in response to a glitches, and there was the possibility of a new online connection that occurred before a confirmation of an offline status request for the previous connection. This situation can be handled using the connection ID as the new connection ID will remain in the data set. Some embodiments utilize the key to readily determine an activity and/or online status (e.g., a key is not present, key length is set to 1 with default value, etc.). Further, in some embodiments, the key automatically expires based on the threshold duration (e.g., 20 seconds).

When a user is considered offline (either due to threshold expiration, disconnection and/or other such conditions), message intended for that user can be prevented from being appended for that user and/or sent over the websocket. Instead, the communication system 100, in some embodiments, can utilize a notification service to handle offline messages for that user. These offline messages may be sent to a notification service 224 to send one or more messages, such as sent as one or more push notifications to the user device. This can be implemented to provide users with timely updates even when the users are disconnected and/or not actively participating in a communication.

The communication system 100 provides a unique approach to solving challenges of real-time communications and/or messaging in highly scalable environments, in part through the user of one or more container orchestration systems, such as but not limited to Kubernetes and/or other such container orchestration systems. Further, some embodiments utilize a websockets protocol and appending data segment queuing (e.g., Redis stream(s)), that can be distributed to each of multiple active containerized applications providing cross-application message routing in a dynamic infrastructure. Still further, some embodiments track an activity status of the different users of the different conversations through a table, data set or the like (e.g., Redis set) in real time enabling enhanced computational resource management while maintaining accurate routing of messages.

In operation, some embodiments initiate a conversation in response to a first user request, communication or the like, such as but not limited to a first user initiating a conversation to chat with one or more intended recipient users (e.g., a second user). A connection can be established (e.g., websocket connection) in response to the request. In some embodiments, the communication system 100 implementation an authentication using one or more authentication methods, and/or can perform an authorization check to ensure that the first user and/or the intended one or more recipient users is/are authorized and part of a conversation. Some embodiments further determine whether there is a communication history, and in some instances may retrieve communication history content (e.g., chat history when available and/or relevant). In establishing a connection, some embodiments manage an active or online status, which may include, for example, the starting of a background thread to detect communications and/or send ping/pong signals (e.g., periodically, based on a schedule, in response to one or more thresholds, etc.), and track users' status (e.g., mark a first user as online in a data set 222) based on the determined status and/or whether or not a response is received.

Messages of a conversation sent from a first user can be directed to the message processing platform 220 to be processed, and in some instances, an acknowledgement 514, 516 can be provided to the first user. The message intended for at least a second user can further be directed to the adapter application 214. An active or online status of the second user can be determined (e.g., through the data set 222), and when the second user is online, the adapter application 214 can incorporate the message in a data segment 208 that is appended to the appended data stream 210 (e.g., Redis stream) in queuing the message for routing to the containerized applications 202. Similarly, when the second user is offline the message, in some embodiments, can be retained for later incorporation into a data segment and/or directed to a notification service 224 to handle offline messages. In some embodiments, each of the containerized applications 202 (e.g., websocket service pods) receive the queued data segments 208, including the data segment intended for at least the second user. The specific containerized application assigned to the corresponding conversation ID and the second user can identify that it is responsible for relaying the message to the second user, and control the transceiver 107 to deliver at least a relevant portion of the message to the intended second user, while the other containerized applications unassociated with the second user for the conversation disregard the data segment. As such, the communication system accurately identifies active users and reliably delivering messages via the queued data segments 208 appended into the appended data stream 210 (e.g., Redis stream(s)) and trying to ensure no message is lost.

Previous systems often rely on static server architectures or centralized message brokers, which create bottlenecks and limit horizontal scalability. In contrast, the communication system 100 utilizes the appended data stream 210 not just as a message queue, but as a dynamic routing mechanism that seamlessly integrates with the containerized applications (e.g., utilizing Kubernetes), and enabling real-time delivery of messages across multiple containerized applications 202 without direct containerized application addressing. Additionally, the communication system 100 uses the user presence detection and message delivery mechanism, using a data set (e.g., Redis) with threshold timing (e.g., time-to-live (TTL)) tracking, to control message transmission and routing such that messages are sent to active users, optimizing resource usage and reducing unnecessary overhead. This approach, which efficiently handles both online and offline clients while scaling across a container environment (e.g., Kubernetes environment), is a significant technological advancement over previous solutions. Moreover, the communication solution incorporates dynamic authentication and authorization mechanisms, providing secure access to conversations and message delivery, making the communication system 100 a comprehensive, secure, and scalable messaging system that is distinct from previous solutions. The communication system can operate as a lightweight, non-blocking architecture, which in some embodiments can leverage Node.js, further enhancing its scalability and responsiveness, making the system highly efficient in large-scale deployments. Further, in at least some embodiments, the communication system 100 provides a solution that can be used as low latency full duplex communication infrastructure across one or more organizations. Further, the communication system can eliminate the use of third party vendors to provide real time communication at reduced costs.

For example, the communication system enables real-time communications, including chat, text, audio, etc., through a websocket platform while improving communication between users, which may include people, automated agents, generative artificial intelligence (AI) agents and/or other users, while offering nearly immediate connection between the two or more parties. In some embodiments, the communication system provides a communication method that provides almost instantaneous message delivery to users at significantly reducing latency.

Some embodiments provide systems comprising: a processing resource; and a non-transitory machine readable medium communicatively coupled with the processing resource and storing instructions, that when executed, cause the processing resource to: receive, from a first user via a distributed communications network, through a first containerized application of multiple active containerized applications a first message of a first conversation between the first user and a second user; append, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and each of the multiple active containerized applications receives the appended data stream over time to receive each of sequential data segments of the multiple different conversations from the appended data stream, wherein a second containerized application of the multiple containerized applications when executed: determines, in response to receiving the first data segment from the appended data stream, that the second containerized application is associated with the first conversation ID, and identifies, based on the first conversation ID, that the second containerized application is previously assigned to forward messages of the first conversation to the second user; and transmits, via the distributed communications network, the first message to the second user in response to the second containerized application identifying that the second containerized application is assigned to relay communications with the second user for the first conversation ID. In some embodiments, the system comprises a third containerized application, of the multiple containerized applications, that when executed further determines, in response to receiving the first data segment from the appended data stream, that the third containerized application is not associated with the first conversation ID, and disregards the first data segment in response to the third containerized application determining that the third containerized application is not associated with the first conversation ID.

Each of the multiple active containerized applications, in some embodiments, when executed: identifies, for each data segment of the appended data stream, a respective conversation ID; and disregards each data segment of the appended data stream for which the corresponding containerized application has not been associated with the respective conversation ID. Further, in some embodiments, the processing resource in executing the instructions further: receives, from the first user and prior to the first message, a conversation request to establish a conversation; establishes, in response to the conversation request, an association of the first user with the first containerized application; creates, by the processing resource, the first conversation ID exclusively associated with the first conversation; associates the second user with the first conversation ID; and maintains, within a conversation database, the association between the first conversation ID and each of the first user identifier (ID) and the second user ID. The processing resource in executing the instructions can in some embodiments further: receive a communication, via a third containerized application of the multiple active containerized applications, from a third user comprising a second message, a designation indicating the second message is associated with the first conversation ID, and a third user ID; determine that the third user ID is not associated with the first conversation ID; and prevent the second message from being appended to the appended data stream in response to the determination that the third user ID is not associated with the first conversation ID. In some embodiments, the communication system further comprises: a message database, and the processing resource in executing the instructions further: receives at a first time a communication, via the first containerized application, from the first user comprising a second message, and a designation indicating the second message is associated with the first conversation ID; causes the second message to be stored in the message database in association with the first conversation ID; identifies that the second user is offline; and at least temporarily prevent the second message from being appended to the appended data stream in response to identifying that the second user is offline.

The processing resource in executing the instructions, in some embodiments, further: determines, at a second time that is subsequent in time to the first time, that the second user is online and is associated with the first conversation ID; identifies that one or more saved messages associated with the first conversation ID are pending and saved in the message database, wherein the one or more saved messages comprises the second message; and causes the one or more saved messages to be communicated through the second containerize application associated with the second user and the conversation ID. The processing resource in executing the instructions can in some embodiments further connect the second user with a third containerized application, which is different than the second containerized application, upon reestablishing an online connection, and assigns the third containerized application to be in communication with the second user for the first conversation ID, where the third containerized application is to determine, in response to receiving the second data segment from the appended data stream, that the third containerized application is associated with the first conversation ID and assigned to forward messages of the first conversation to the second user, and transmits, via the distributed communications network, the second message to the second user in response to the third containerized application identifying that the third containerized application is assigned to relay communications with the second user for the first conversation ID. Further, in some embodiments, the processing resource in executing the instructions: identifies that a tracking duration threshold has expired since a confirmation that the second user is online; and controls a transceiver to communicate, via the distributed communications network, a confirmation request to the second user; wherein the identifying that the second user is offline comprises identifying that an online confirmation response is not received within a second threshold duration from the communication of the confirmation request.

Some embodiments provide methods comprising: receiving, from a first user via a distributed communications network through a first containerized application of multiple active containerized applications, a first message of a first conversation between the first user and a second user; appending, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and receiving, at each of the multiple active containerized applications, the appended data stream over time to receive each of sequential data segments of the multiple different conversations from the appended data stream; determining, at a second containerized application of the multiple containerized applications and in response to receiving the first data segment from the appended data stream, that the second containerized application is associated with the first conversation ID; identifying, at the second containerized application and based on the first conversation ID, that the second containerized application is previously assigned to forward messages of the first conversation to the second user; and transmitting, by the second containerized application via the distributed communications network, the first message to the second user in response to the second containerized application identifying that the second containerized application is assigned to relay communications with the second user for the first conversation ID. The method, in some embodiments, further comprises: determining, at a third containerized application of the multiple containerized applications and in response to the third containerized application receiving the first data segment from the appended data stream, that the third containerized application is not associated with the first conversation ID; and disregarding, at the third containerized application, the first data segment in response to the third containerized application determining that the third containerized application is not associated with the first conversation ID.

Further, in some embodiments, the method comprises: identifying, at each of the multiple active containerized applications and for each data segment of the appended data stream, a respective conversation ID; and disregarding, at each of the multiple active containerized applications, each data segment of the appended data stream for which the corresponding containerized application has not been associated with the respective conversation ID. In some embodiments, the method comprises: receiving, from the first user and prior to the first message, a conversation request to establish a conversation; establishing, in response to the conversation request, an association of the first user with the first containerized application; creating the first conversation ID exclusively associated with the first conversation; associating the second user with the first conversation ID; maintaining, within a conversation database, the association between the first conversation identifier (ID) and each of the first user ID and the second user ID; and.

In some embodiments, methods further comprise: receiving a communication, via a third containerized application of the multiple active containerized applications, from a third user, wherein the communication comprises a second message, a designation indicating the second message is associated with the first conversation ID, and a third user ID; determining that the third user ID is not associated with the first conversation ID; and preventing the second message from being appended to the appended data stream in response to determining that the third user ID is not associated with the first conversation ID. The methods, in some implementations, further comprise: receiving at a first time a communication, via the first containerized application, from the first user comprising a second message, and a designation indicating the second message is associated with the first conversation ID; causing the second message to be stored in a message database in association with the first conversation ID; identifying that the second user is offline; and at least temporarily preventing the second message from being appended to the appended data stream response to identify that the second user is offline. The methods can further comprise: determining, at a second time that is subsequent in time to the first time, that the second user is online and is associated with the first conversation ID; identifying that one or more saved messages associated with the first conversation ID are pending and saved in the message database, wherein the one or more saved messages comprises the second message; and causing the one or more saved messages to be communicated through the second containerize application associated with the second user and the conversation ID, which may be in response to a connection request. In some embodiments, methods can further comprise: connecting the second user with a third containerized application, which is different than the second containerized application, upon reestablishing an online connection with the second user, and assigning the third containerized application to be in communication with the second user for the first conversation ID; determining, at the third containerized application and in response to receiving the second data segment from the appended data stream, that the third containerized application is associated with the first conversation ID and assigned to forward messages of the first conversation to the second user; and transmitting, via the distributed communications network, the second message to the second user in response to the third containerized application identifying that the third containerized application is assigned to relay communications with the second user for the first conversation ID. Some embodiments further comprise: identifying that a tracking duration threshold has expired since a confirmation that the second user is online; and controlling a transceiver to communicate, via the distributed communications network, a confirmation request to the second user; wherein the identifying that the second user is offline comprises identifying that an online confirmation response is not received within a second threshold duration from the communication of the confirmation request.

Still further, some embodiments provide and/or comprise non-transitory machine readable medium storing instructions that, when executed, cause a processing resource to: receive, from a first user via a distributed communications network through a first containerized application of multiple active containerized applications, a first message of a first conversation between the first user and a second user; append, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and receive, at each of the multiple active containerized applications, the appended data stream over time to receive each of sequential data segments of the multiple different conversations from the appended data stream; determine, at a second containerized application of the multiple containerized applications and in response to receiving the first data segment from the appended data stream, that the second containerized application is associated with the first conversation ID; identify, at the second containerized application and based on the first conversation ID, that the second containerized application is previously assigned to forward messages of the first conversation to the second user; and transmit, by the second containerized application via the distributed communications network, the first message to the second user in response to the second containerized application identifying that the second containerized application is assigned to relay communications with the second user for the first conversation ID.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system comprising:
a processing resource; and
a non-transitory machine readable medium communicatively coupled with the processing resource and storing instructions, that when executed, cause the processing resource to:
receive, from a first user via a distributed communications network, through a first containerized application of multiple active containerized applications a first message of a first conversation between the first user and a second user;
append, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message; and
each of the multiple active containerized applications receives the appended data stream over time to receive each of sequential data segments of the multiple different conversations from the appended data stream, wherein a second containerized application of the multiple containerized applications when executed:
determines, in response to receiving the first data segment from the appended data stream, that the second containerized application is associated with the first conversation ID, and identifies, based on the first conversation ID, that the second containerized application is previously assigned to forward messages of the first conversation to the second user; and
transmits, via the distributed communications network, the first message to the second user in response to the second containerized application identifying that the second containerized application is assigned to relay communications with the second user for the first conversation ID.

2. The system of claim 1, wherein a third containerized application, of the multiple containerized applications, when executed further determines, in response to receiving the first data segment from the appended data stream, that the third containerized application is not associated with the first conversation ID, and disregards the first data segment in response to the third containerized application determining that the third containerized application is not associated with the first conversation ID.

3. The system of claim 2, wherein each of the multiple active containerized applications, when executed:
identifies, for each data segment of the appended data stream, a respective conversation ID; and
disregards each data segment of the appended data stream for which the corresponding containerized application has not been associated with the respective conversation ID.

4. The system of claim 2, wherein the processing resource in executing the instructions further:
receives, from the first user and prior to the first message, a conversation request to establish a conversation;
creates, by the processing resource, the first conversation ID exclusively associated with the first conversation;
establishes, in response to the conversation request, an association of the first user with the first containerized application;
associates the second user with the first conversation ID; and
maintains, within a conversation database, the association between the first conversation ID and each of the first user identifier (ID) and the second user ID.

5. The system of claim 2, wherein the processing resource in executing the instructions further:
receives a communication, via a third containerized application of the multiple active containerized applications, from a third user comprising a second message, a designation indicating the second message is associated with the first conversation ID, and a third user ID;
determines that the third user ID is not associated with the first conversation ID; and
prevents the second message from being appended to the appended data stream in response to the determination that the third user ID is not associated with the first conversation ID.

6. The system of claim 1, further comprising:
a message database; and
wherein the processing resource in executing the instructions further:
receives at a first time a communication, via the first containerized application, from the first user comprising a second message, and a designation indicating the second message is associated with the first conversation ID;
causes the second message to be stored in the message database in association with the first conversation ID;
identifies that the second user is offline; and
prevent the second message from being appended to the appended data stream in response to identifying that the second user is offline.

7. The system of claim 6, wherein the processing resource in executing the instructions further:
determines, at a second time that is subsequent in time to the first time, that the second user is online and is associated with the first conversation ID;
identifies that one or more saved messages associated with the first conversation ID are pending and saved in the message database, wherein the one or more saved messages comprises the second message; and
causes the one or more saved messages to be communicated through the second containerize application associated with the second user and the conversation ID.

8. The system of claim 7, wherein the processing resource in executing the instructions further connects the second user with a third containerized application, which is different than the second containerized application, upon reestablishing an online connection, and assigns the third containerized application to be in communication with the second user for the first conversation ID;
wherein the third containerized application is to determine, in response to receiving the second data segment from the appended data stream, that the third containerized application is associated with the first conversation ID and assigned to forward messages of the first conversation to the second user, and
transmits, via the distributed communications network, the second message to the second user in response to the third containerized application identifying that the third containerized application is assigned to relay communications with the second user for the first conversation ID.

9. The system of claim 6, wherein the processing resource in executing the instructions further:
identifies that a tracking duration threshold has expired since a confirmation that the second user is online; and
controls a transceiver to communicate, via the distributed communications network, a confirmation request to the second user;
wherein the identifying that the second user is offline comprises identifying that an online confirmation response is not received within a second threshold duration from the communication of the confirmation request.

10. A method comprising:
receiving, from a first user via a distributed communications network through a first containerized application of multiple active containerized applications, a first message of a first conversation between the first user and a second user;
appending, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message;
receiving, at each of the multiple active containerized applications, the appended data stream over time to receive each of sequential data segments of the multiple different conversations from the appended data stream;
determining, at a second containerized application of the multiple containerized applications and in response to receiving the first data segment from the appended data stream, that the second containerized application is associated with the first conversation ID;
identifying, at the second containerized application and based on the first conversation ID, that the second containerized application is previously assigned to forward messages of the first conversation to the second user; and
transmitting, by the second containerized application via the distributed communications network, the first message to the second user in response to the second containerized application identifying that the second containerized application is assigned to relay communications with the second user for the first conversation ID.

11. The method of claim 10, further comprising:
determining, at a third containerized application of the multiple containerized applications and in response to the third containerized application receiving the first data segment from the appended data stream, that the third containerized application is not associated with the first conversation ID; and
disregarding, at the third containerized application, the first data segment in response to the third containerized application determining that the third containerized application is not associated with the first conversation ID.

12. The method of claim 11, further comprising:
identifying, at each of the multiple active containerized applications and for each data segment of the appended data stream, a respective conversation ID; and
disregarding, at each of the multiple active containerized applications, each data segment of the appended data stream for which the corresponding containerized application has not been associated with the respective conversation ID.

13. The method of claim 11, further comprising:
receiving, from the first user and prior to the first message, a conversation request to establish a conversation;
creating the first conversation ID exclusively associated with the first conversation;
establishing, in response to the conversation request, an association of the first user with the first containerized application;
associating the second user with the first conversation ID; and
maintaining, within a conversation database, the association between the first conversation ID and each of the first user identifier (ID) and the second user ID.

14. The method of claim 11, further comprising:
receiving a communication, via a third containerized application of the multiple active containerized applications, from a third user, wherein the communication comprises a second message, a designation indicating the second message is associated with the first conversation ID, and a third user ID;
determining that the third user ID is not associated with the first conversation ID; and
preventing the second message from being appended to the appended data stream in response to determining that the third user ID is not associated with the first conversation ID.

15. The method of claim 10, further comprising:
receiving at a first time a communication, via the first containerized application, from the first user comprising a second message, and a designation indicating the second message is associated with the first conversation ID;
causing the second message to be stored in a message database in association with the first conversation ID
identifying that the second user is offline; and
preventing the second message from being appended to the appended data stream in response to identifying that the second user is offline.

16. The method of claim 15, further comprising:
determining, at a second time that is subsequent in time to the first time, that the second user is online and is associated with the first conversation ID;
identifying that one or more saved messages associated with the first conversation ID are pending and saved in the message database, wherein the one or more saved messages comprises the second message; and
causing the one or more saved messages to be communicated through the second containerize application associated with the second user and the conversation ID.

17. The method of claim 16, further comprising:
connecting the second user with a third containerized application, which is different than the second containerized application, upon reestablishing an online connection with the second user, and assigning the third containerized application to be in communication with the second user for the first conversation ID;
determining, at the third containerized application and in response to receiving the second data segment from the appended data stream, that the third containerized application is associated with the first conversation ID and assigned to forward messages of the first conversation to the second user; and
transmitting, via the distributed communications network, the second message to the second user in response to the third containerized application identifying that the third containerized application is assigned to relay communications with the second user for the first conversation ID.

18. The method of claim 15, further comprising:
identifying that a tracking duration threshold has expired since a confirmation that the second user is online; and
controlling a transceiver to communicate, via the distributed communications network, a confirmation request to the second user;
wherein the identifying that the second user is offline comprises identifying that an online confirmation response is not received within a second threshold duration from the communication of the confirmation request.

19. A non-transitory machine readable medium storing instructions that, when executed, cause a processing resource to:
receive, from a first user via a distributed communications network through a first containerized application of multiple active containerized applications, a first message of a first conversation between the first user and a second user;
append, in response to receiving the first message of the first conversation, a first data segment to an appended data stream to which each data segment of multiple different conversations is sequentially appended over time, wherein the first data segment comprises: a first conversation identifier (ID) corresponding to the first conversation, and the first message;
receive, at each of the multiple active containerized applications, the appended data stream over time to receive each of sequential data segments of the multiple different conversations from the appended data stream;
determine, at a second containerized application of the multiple containerized applications and in response to receiving the first data segment from the appended data stream, that the second containerized application is associated with the first conversation ID;
identify, at the second containerized application and based on the first conversation ID, that the second containerized application is previously assigned to forward messages of the first conversation to the second user; and
transmit, by the second containerized application via the distributed communications network, the first message to the second user in response to the second containerized application identifying that the second containerized application is assigned to relay communications with the second user for the first conversation ID.
